(19) United States
(12) Patent Application Publication
(10) Pub. No.: US 2024/0151853 A1
(43) Pub. Date: May 9, 2024

(54) MEASUREMENT DEVICE, MEASUREMENT METHOD, AND INFORMATION PROCESSING DEVICE

(71) Applicant: Sony Semiconductor Solutions Corporation, Kanagawa (JP)

(72) Inventors: Yuusuke Kawamura, Kanagawa (JP); Kazutoshi Kitano, Kanagawa (JP); Kousuke Takahashi, Kanagawa (JP); Takeshi Kubota, Kanagawa (JP)

(21) Appl. No.: 18/550,064

(22) PCT Filed: Jan. 25, 2022
(86) PCT No.: PCT/JP2022/002515

§ 371 Date: Sep. 11, 2023

Related U.S. Application Data
(60) Provisional application No. 63/162,217, filed on Mar. 17, 2021.

(51) Int. Cl. G01S 17/894; G01S 7/481; G01S 7/4865; G01S 7/499; G01S 17/04; G01S 17/10

(52) U.S. Cl. CPC G01S 17/894; G01S 7/4813; G01S 7/4865; G01S 7/499; G01S 17/04; G01S 17/10

(57) ABSTRACT

A measurement device according to an embodiment includes: a receiving unit (100, 102) that receives reflected light of laser light reflected by a target object and polarization-separates the received reflected light into first polarized light and second polarized light, and a recognition unit (122) that performs object recognition on the target object on the basis of the first polarized light and the second polarized light.

### FIELD

The present disclosure relates to a measurement device, a measurement method, and an information processing device.

### BACKGROUND

As one of methods for performing distance measurement using light, a technology called laser imaging detection and ranging (LiDAR) for performing distance measurement using laser light is known. In the LiDAR, the distance to an object to be measured is measured using reflected light of emitted laser light reflected by the object to be measured.

### CITATION LIST

### Patent Literature

Patent Literature 1: JP 2020-4085 A

### SUMMARY

### Technical Problem

In conventional distance measurement using LiDAR, for example, in a case where measurement is performed in a situation where there is a surface with high reflectivity (walls, floors, or the like), an object ahead of the laser light reflected by a reflection surface may be measured at the same time as the reflection surface. However, in this case, the object is erroneously detected as being present on an extension that has passed through the reflection surface of the light beam.

An object of the present disclosure is to provide a measurement device and a measurement method capable of performing distance measurement using laser light with higher accuracy, and an information processing device.

### Solution to Problem

For solving the problem described above, a measurement device according to one aspect of the present disclosure has a receiving unit that receives reflected light of laser light reflected by a target object and polarization-separates the received reflected light into first polarized light and second polarized light; and a recognition unit that performs object recognition on the target object on a basis of the first polarized light and the second polarized light.

### BRIEF DESCRIPTION OF DRAWINGS

FIG. 1 is a schematic diagram for describing an existing technology.

FIG. 2 is a schematic diagram illustrating an example of measuring a distance to a measurement point on a glossy floor surface using a distance measuring device according to the existing technology.

FIG. 3 is a schematic diagram illustrating an example of signal intensity in a case where a distance to a measurement point on a glossy floor surface is measured using the distance measuring device according to the existing technology.

FIG. 4 is a schematic diagram illustrating an example of an actual measurement result.

FIG. 5 is a schematic diagram illustrating another example of erroneous detection in distance measurement according to the existing technology.

FIG. 6 is a schematic diagram illustrating still another example of erroneous detection in distance measurement according to the existing technology.

FIG. 7 is a schematic diagram for schematically describing a distance measuring method according to the present disclosure.

FIG. 8 is a schematic diagram illustrating an example of an actual measurement result based on a polarization ratio.

FIG. 9 is a block diagram schematically illustrating a configuration of an example of a measurement device applicable to each embodiment of the present disclosure.

FIG. 10 is a block diagram illustrating a configuration of an example of a measurement device according to a first embodiment.

FIG. 11 is a block diagram illustrating a configuration of an example of a photodetection distance measuring unit according to the first embodiment.

FIG. 12 is a schematic diagram schematically illustrating an example of scanning of transmission light by a scanning unit.

FIG. 13 is a block diagram illustrating a configuration of an example of a reception signal processing unit according to the first embodiment.

FIG. 14 is a schematic diagram illustrating an example of signals output from a TE receiving unit and a TM receiving unit.

FIG. 15 is a schematic diagram illustrating an example of a result of obtaining a polarization component ratio between TM polarized light and TE polarized light.

FIG. 16 is a schematic diagram for describing an example of processing according to an existing technology.

FIG. 17 is a flowchart of an example illustrating distance measurement processing according to the first embodiment.

FIG. 18 is a schematic diagram illustrating an example of a highly reflective object.

FIG. 19 is a schematic diagram illustrating an example of a high transmittance object.

FIG. 20 is a block diagram illustrating a configuration of an example of a photodetection distance measuring unit according to a modification of the first embodiment.

FIG. 21 is a block diagram illustrating a configuration of an example of a measurement device according to a second embodiment.

FIG. 22 is a flowchart of an example illustrating processing according to the second embodiment.

FIG. 23 is a diagram illustrating a first embodiment and a modification thereof according to another embodiment of the present disclosure, and a usage example using the measurement device according to the second embodiment.

### DESCRIPTION OF EMBODIMENTS

Hereinafter, embodiments of the present disclosure will be described in detail with reference to the drawings. Note that, in the following embodiment, the same parts are denoted by the same reference numerals, and redundant description is omitted.

Hereinafter, embodiments of the present disclosure will be described in the following order.
1. Existing Technology
2. Outline of Present Disclosure
3. First Embodiment
3-1. Configuration According to First Embodiment
3-2. Processing According to First Embodiment
4. Modification of First Embodiment
5. Second Embodiment
6. Other Embodiments

### 1. EXISTING TECHNOLOGY

Prior to describing embodiments of the present disclosure, an existing technology will be schematically described for ease of understanding.

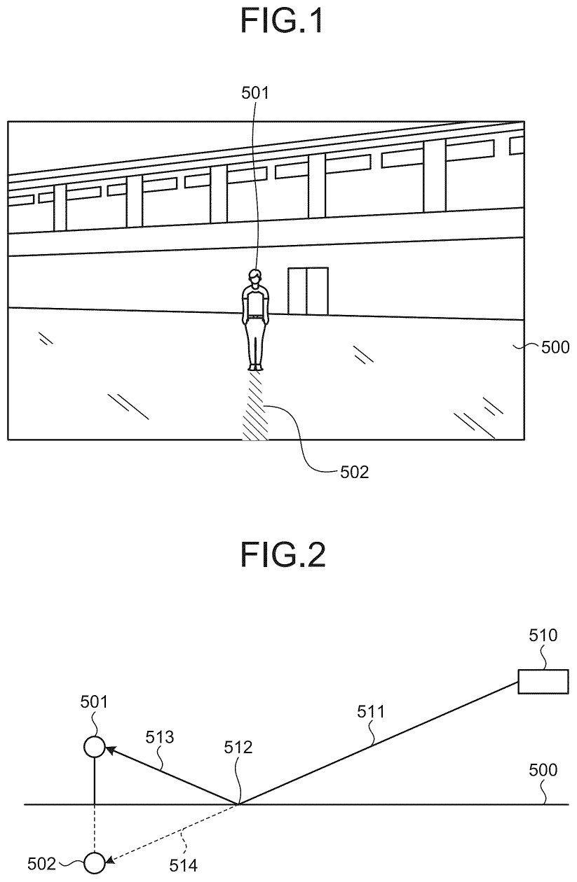

FIG. 1 is a schematic diagram for describing an existing technology. As illustrated in FIG. 1, a situation is considered where an object 501 (a person in this example) is present on a glossy floor surface 500. In this situation, when an observer observes the floor surface 500, the observer observes the floor surface 500 and a virtual image 502 generated by that the image of the object 501 on the floor surface 500 is reflected on the floor surface 500.

FIG. 2 is a schematic diagram illustrating an example of measuring a distance to a measurement point on the glossy floor surface 500 using a distance measuring device according to the existing technology. In FIG. 2, for example, a laser imaging detection and ranging (LiDAR) method is applied, and a measurement device 510 irradiates the object to be measured with a light beam of laser light and performs distance measurement on the basis of the reflected light. For example, the measurement device 510 outputs a distance measurement result as a point cloud that is a set of points having position information.

In the example of FIG. 2, the measurement device 510 emits a light beam through an optical path 511 toward a position 512 as a measurement point, the position 512 being in front of the object 501 on an upper portion of the floor surface 500 as a reflection surface. The emitted light beam is reflected at a reflection angle equal to an incident angle on the floor surface 500 at the position 512, and irradiates the object 501, for example, as illustrated in an optical path 513. Reflected light of the light beam from the object 501 is received by the measurement device 510 by reversely tracing the optical paths 513 and 511. Furthermore, the direct reflected light from the position 512 of the light beam is also received by the measurement device 510 following the optical path 511 in reverse.

In this case, the measurement device 510 detects, as the object 501, the virtual image 502 that appears at a line-symmetric position with respect to the object 501 and the floor surface 500 on an extension line 514 extending the optical path 511 from the position 512 to below the floor surface 500. That is, the measurement device 510 erroneously detects a point on the virtual image 502 as a point on the extension line 514 where the optical path 511 of the light beam passes through the floor surface 500.

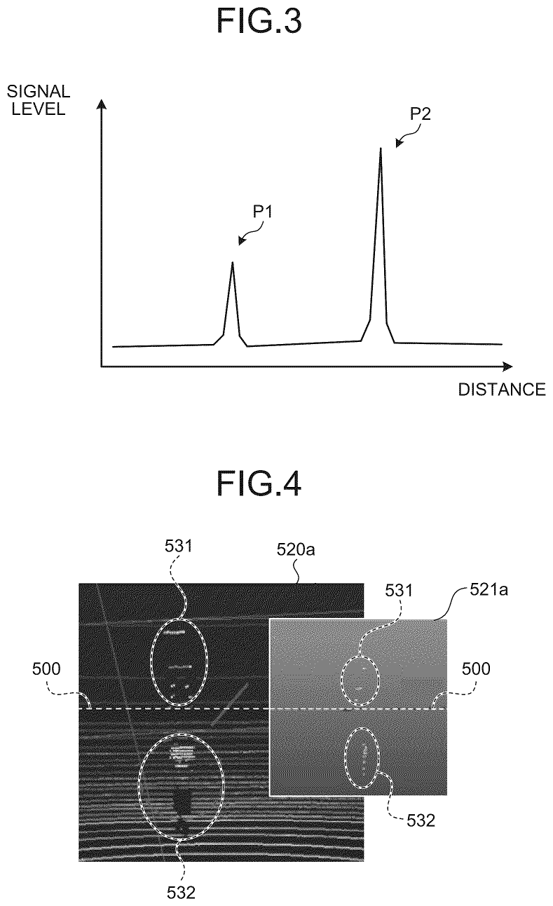

FIG. 3 is a schematic diagram illustrating an example of signal intensity in a case where the distance to the measurement point on the glossy floor surface 500 is measured using a distance measuring device according to the existing technology. In FIG. 3, the vertical axis represents the signal level of reception light by the measurement device 510, and the horizontal axis represents the distance. Note that the distance corresponds to the length of the optical path of the light beam emitted from the measurement device 510.

Furthermore, in this example, a peak P1 indicates a peak of the signal level by reflected light from the position 512, and a peak P2 indicates a peak of the signal level by reflected light from the object 501. That is, the distance corresponding to the peak P1 is the original distance to the measurement target. Furthermore, the distance corresponding to the peak P2 is the distance to the object 501 detected as the virtual image 502. In this example, the peak P2 is larger than the peak P1, the peak P1 is processed as noise, and the distance corresponding to the peak P2 may be erroneously detected as the distance to be measured.

FIG. 4 is a schematic diagram illustrating an example of an actual measurement result for the situation of FIG. 3. In FIG. 4, a measurement result 520a illustrates an example of a case of viewing the direction of the position 512 (object 501) from the measurement device 510, and a measurement result 521a illustrates an example of a case of viewing the direction from the side. As exemplified in the measurement results 520a and 521a, a point cloud 531 corresponding to the object 501 is detected, and a point cloud 532 corresponding to the virtual image 502 is erroneously detected. On the other hand, the peak P1 is not detected because the noise processing is performed on the peak P1 at the position 512.

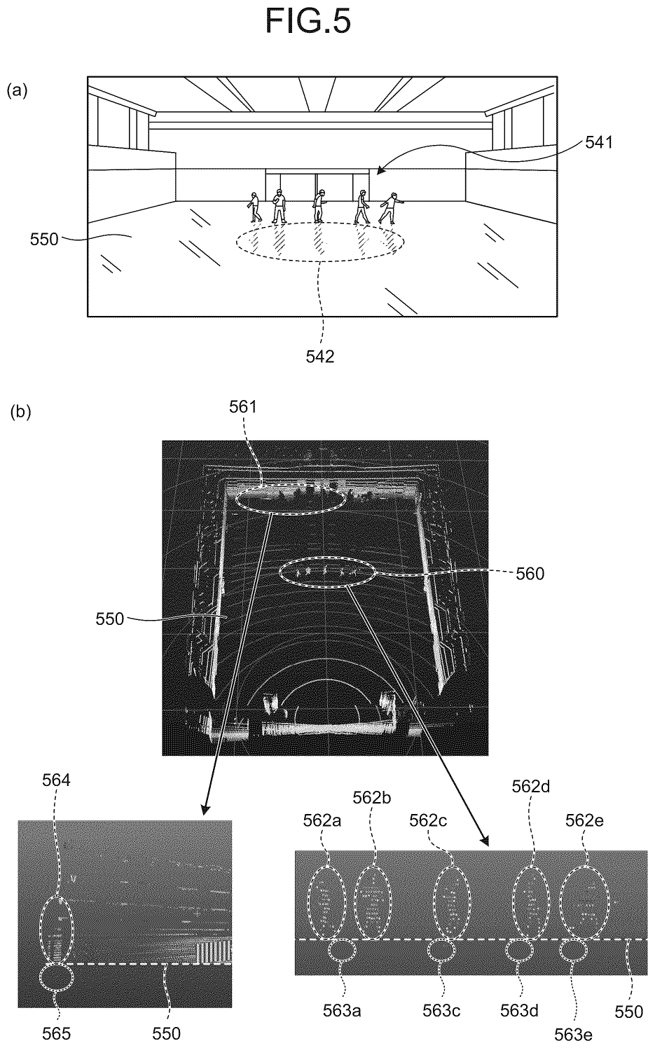

FIG. 5 is a schematic diagram illustrating another example of erroneous detection in distance measurement according to the existing technology. In FIG. 5, as illustrated in section (a), a plurality of persons 541 as objects to be measured stands indoors on a floor surface 550 as a reflection surface. Furthermore, a virtual image 542 is projected on the floor surface 550 corresponding to each of the plurality of persons 541. In the situation of section (a) of FIG. 5, for example, when a front position of the plurality of persons 541 on the floor surface 550 is set as the measurement point, there is a possibility that the virtual image 542 is erroneously detected as described above.

Section (b) of FIG. 5 illustrates an example of actual measurement results for the situation of section (a). The upper diagram of section (b) illustrates the detection results in an overhead view. The lower right diagram of section (b) illustrates an example in which a region 560 corresponding to the plurality of persons 541 is viewed from the direction of the measurement device 510, which is not illustrated. Furthermore, the lower left diagram of section (b) illustrates an example in which a region 561 in the upper diagram is viewed from the direction of the measurement device 510.

In the lower right diagram in section (b), point clouds 563a, 563c, 563d, and 563e corresponding to the virtual images 542 of the plurality of persons 541 are detected with respect to point clouds 562a, 562b, 562c, 562d, and 562e in which the plurality of persons 541 is detected, respectively. Similarly, in the lower left diagram of section (b), a point cloud 565 corresponding to the virtual image of the object is detected with respect to a point cloud 564 in which the object included in the region 561 is detected. These point clouds 563a, 563c, 563d, and 563e and the point cloud 564 are erroneously detected due to reflection of light beams on the floor surface 550.

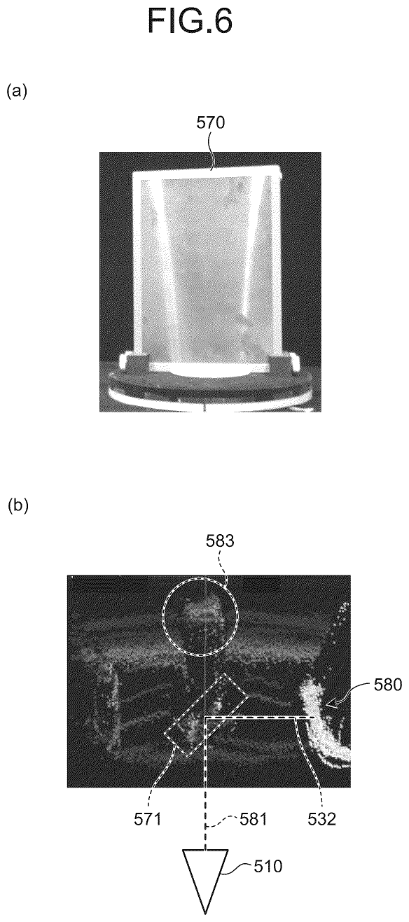

FIG. 6 is a schematic diagram illustrating still another example of erroneous detection in distance measurement according to the existing technology. In FIG. 6, as illustrated in section (a), it is assumed that a glossy metal plate 570 is disposed at an oblique angle (for example, 45° with the left end on the front side) with respect to the measurement device 510, which is not illustrated, disposed on the front side of the drawing. When the distance measurement is performed on the metal plate 570, the light beam emitted from the measurement device 510 is reflected by the metal plate 570, and the direction is changed to a right angle.

Section (b) of FIG. 6 illustrates an example of an actual measurement result for the situation of section (a). The metal plate 570 is irradiated with light emitted from the measurement device 510 following an optical path 581, and a point cloud 571 corresponding to the metal plate 570 is detected. At the same time, the light beam is reflected rightward by the metal plate 570, and the reflected light beam travels along the optical path 581 to irradiate an object 580 existing rightward of the metal plate 570. The reflected light reflected by the object reversely follows optical paths 582 and 581, and travels toward the measurement device 510 via the metal plate 570. The measurement device 510 detects the object 580 on the basis of the reflected light from the object 580. At this time, the measurement device 510 detects a point cloud 583 as a virtual image of the object 580 at a position extending the optical path 581 via the metal plate 570. The point cloud 583 is erroneously detected as a light beam is reflected on the metal plate 570.

In the present disclosure, reception light that is received reflected light by laser light is polarization-separated into polarized light by TE waves (first polarized light) and polarized light by TM waves (second polarized light), and whether or not a target object is a highly reflective object is determined on the basis of each polarization-separated polarized light. Thus, it is possible to prevent the above-described virtual image due to reflection on the reflection surface from being erroneously detected as a target object.

Note that, hereinafter, the polarized light by TE waves is referred to as TE polarized light, and polarized light by TM waves is referred to as TM polarized light.

### 2. OUTLINE OF PRESENT DISCLOSURE

Next, the present disclosure will be schematically described.

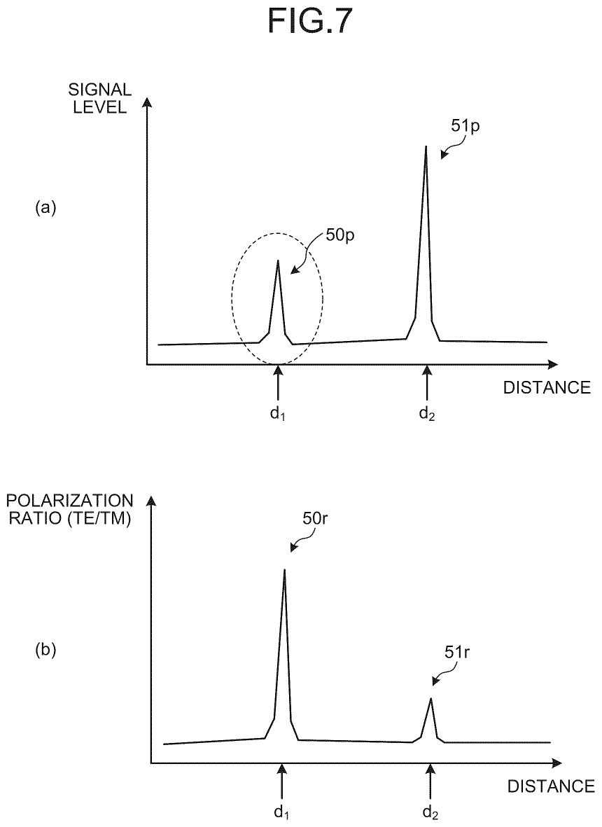

FIG. 7 is a schematic diagram for schematically describing a distance measuring method according to the present disclosure. Note that, in FIG. 7, section (a) is a diagram corresponding to FIG. 3 described above, and a vertical axis indicates a signal level according to reception light, and a horizontal axis indicates a distance from the measurement device. Note that, here, with reference to FIGS. 1 and 2 described above, a description will be given on the assumption that a positional relationship of a measurement target or the like by the measurement device conforms to each position in FIGS. 1 and 2.

It is assumed that the target object of distance measurement is the position 512 in front of the object 501 on the floor surface 500, and the position 512 is at a position of a distance d₁ from the measurement device (optical path 511). Furthermore, it is assumed that a distance from the measurement device to the object 501 via the floor surface 500 is a distance d₂ (optical path 511+optical path 513). A distance from the measurement device to the virtual image 502 via the floor surface 500 is also the distance d₂ (optical path 511+extension line 514).

In this example, a peak 50p appears at the distance d₁, and a peak 51p larger than the peak 50p appears at the distance d₂ farther than the distance d₁. According to the existing technology, as described with reference to FIG. 3, there is a possibility that the peak 50p is processed as noise and the distance d₂ is output as a wrong distance measurement result.

That is, it is determined whether or not the measurement is performed via a reflection surface such as the floor surface 500, and in a case where the measurement is performed via a reflective object, it is necessary to correct the measurement result in consideration of the fact. In order to determine whether or not the measurement is performed via the reflection surface, it is necessary to detect the presence of the reflection surface. In scattering of light on an object surface, a polarization component ratio of reflected light has a characteristic corresponding to a material of the object. For example, when the target is an object of a material having high reflectivity, a polarization ratio obtained by dividing intensity of the TM polarized light by intensity of the TE polarized light tends to increase.

In the present disclosure, using the characteristic of the polarization component ratio related to reflection, the presence of the reflection surface is estimated on the basis of the comparison result obtained by comparing the respective polarization components at the time of measurement. A point measured in an extension line with respect to a point estimated to be the reflection surface from the measurement device is regarded as a measurement point after reflection, that is, a measurement point with respect to the virtual image, and the measurement result is corrected. This makes it possible to correctly detect the position of an object with high reflectivity.

Section (b) in FIG. 7 illustrates an example of a measurement result based on the polarization component ratio in the situation of FIGS. 1 and 2 described above. In section (b) of FIG. 7, the vertical axis represents the polarization ratio, and the horizontal axis represents the distance from the measurement device. In this example, the polarization ratio is indicated as a value obtained by dividing the intensity of the TE polarized light by the intensity of the TM polarized light. The measurement device polarization-separates received light into TE polarized light and TM polarized light, and obtains a ratio between the intensity of the TE polarized light and the intensity of the TM polarized light as a polarization ratio.

Hereinafter, unless otherwise specified, the description will be given assuming that the polarization ratio is a value (TM/TE) obtained by dividing the intensity (TM) of the TE polarized light by the intensity (TE) of the TM polarized light.

In the example of section (b) of FIG. 7, a peak 50r of the polarization ratio at the distance d₁ is larger than a peak 51r of the polarization ratio at the distance d₂. In the reflected light, since the intensity of the TE polarized light tends to be higher than the intensity of the TM polarized light, it can be estimated that the peak 50r corresponds to reflected light by the floor surface 500 that is the reflection surface, and the peak 51r is reflected light by a surface other than the reflection surface. Therefore, in section (a) of FIG. 7, the peak 50p is employed as reflected light by the target object, and the distance to the target object is obtained as the distance d₁.

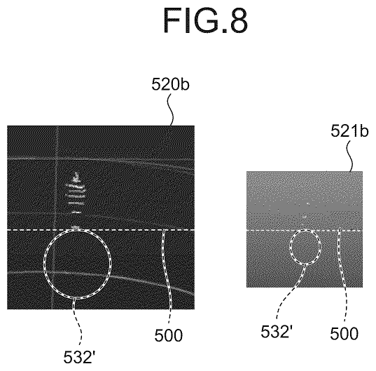

FIG. 8 corresponds to FIG. 4 described above, and is a schematic diagram illustrating an example of a measurement result based on the polarization ratio in section (b) of FIG. 7. In FIG. 8, a measurement result 520b illustrates an example of a case where the direction of the position 512 (object 501) is viewed from the measurement device, and a measurement result 521b illustrates an example of a case where the direction is viewed from the side. In sections (a) and (b) of FIG. 7, the peak 50p corresponding to the peak 50r is employed, and the peak 51p corresponding to the peak 51r is processed as noise, for example. Therefore, as indicated by a range 532′ in the measurement results 520b and 521b in FIG. 8, the point cloud for the virtual image 502 of the object 501 is not detected.

In addition, it is possible to detect an object having high transmittance (referred to as a high transmittance object) such as glass by analyzing TE polarized light and TM polarized light. In this case, it is possible to switch between the detection of a glass surface and the detection of a destination that has transmitted through the glass according to the use of the measurement.

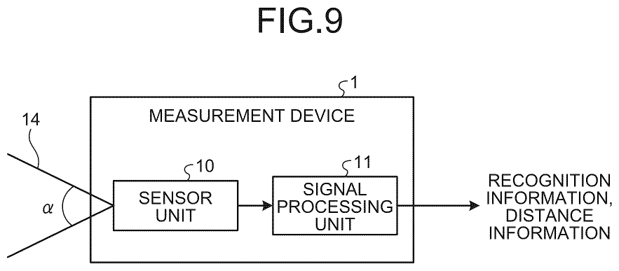

FIG. 9 is a block diagram schematically illustrating a configuration of an example of a measurement device applicable to each embodiment of the present disclosure. In FIG. 9, the measurement device 1 performs distance measurement using LiDAR, and includes a sensor unit 10 and a signal processing unit 11.

The sensor unit 10 includes an optical transmitting unit that transmits laser light, a scanning unit that scans a predetermined angular range a with a laser light 14 transmitted from an optical transmitting unit, an optical receiving unit that receives incident light, and a control unit that controls these units. The sensor unit 10 outputs a point cloud that is a set of points each having three-dimensional position information (distance information) on the basis of the emitted laser light 14 and the light received by the optical receiving unit.

Further, the sensor unit 10 polarization-separates light received by the light receiving unit into TE polarized light and TM polarized light, and obtains the intensity of each of the TE polarized light and the TM polarized light. The sensor unit 10 may include intensity information indicating the intensity of each of the TE polarized light and the TM polarized light in the point cloud and output the point cloud.

Although details will be described later, the sensor unit 10 polarization-separates the incident light into TE polarized light and TM polarized light, and sets a distance measuring mode on the basis of the TE polarized light and the TM polarized light that have been polarization-separated. The distance measuring mode includes, for example, a highly reflective object distance measuring mode for detecting the presence of a highly reflective object having high reflectivity, a high transmittance object distance measuring mode for detecting an object having high transmittance, and a normal distance measuring mode not considering the highly reflective object and the high transmittance object. In addition, the high transmittance object distance measuring mode includes a transmission object surface distance measuring mode for measuring a distance to the surface of the high transmittance object and a transmission destination distance measuring mode for measuring a distance to an object ahead of the high transmittance object.

Note that the sensor unit 10 may apply LiDAR (hereinafter referred to as dToF-LiDAR) using a direct time-of-flight (dToF) method for performing distance measurement using laser light modulated by a pulse signal of a constant frequency, or may apply frequency modulated continuous wave (FMCW)-LiDAR using continuously frequency-modulated laser light.

The signal processing unit 11 performs object recognition on the basis of the point cloud output from the sensor unit 10, and outputs recognition information and distance information. At this time, the signal processing unit 11 extracts a point cloud from the point cloud output from the sensor unit 10 according to the distance measuring mode, and performs object recognition on the basis of the extracted point cloud.

### 3. FIRST EMBODIMENT

Next, a first embodiment of the present disclosure will be described. The first embodiment is an example in which dToF-LiDAR among LiDAR is applied as a distance measuring method.

### 3-1. Configuration According to First Embodiment

A configuration according to the first embodiment will be described.

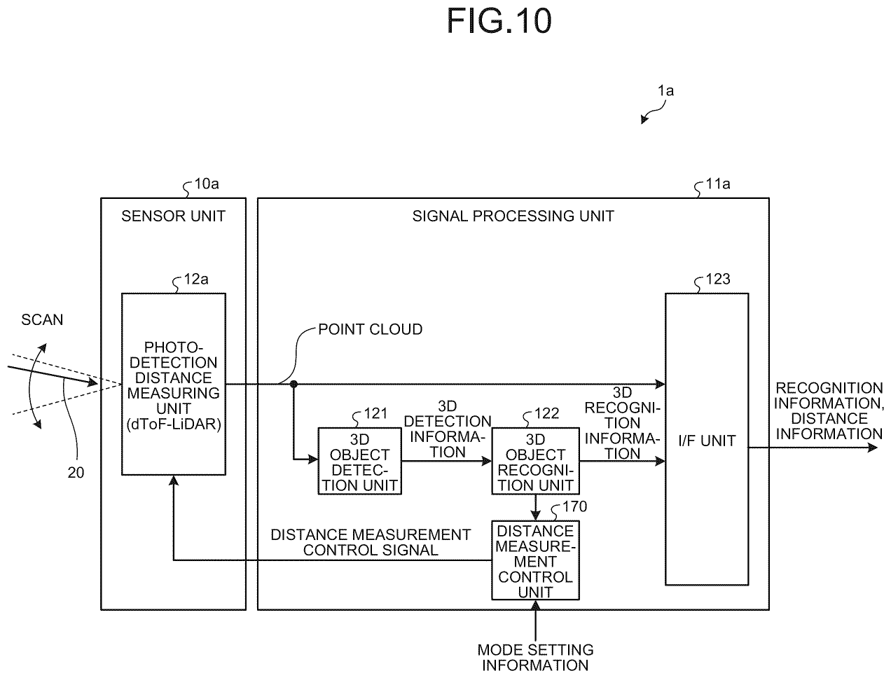

FIG. 10 is a block diagram illustrating a configuration of an example of a measurement device according to the first embodiment. In FIG. 10, a measurement device 1a includes a sensor unit 10a, a signal processing unit 11a, and an abnormality detection unit 20. The sensor unit 10a includes a photodetection distance measuring unit 12a and the signal processing unit 11a. The signal processing unit 11a includes a 3D object detection unit 121, a 3D object recognition unit 122, an I/F unit 123, and a distance measurement control unit 170.

The 3D object detection unit 121, the 3D object recognition unit 122, the I/F unit 123, and the distance measurement control unit 170 can be configured by, for example, executing a measurement program according to the present disclosure on a CPU. Not limited to this, part or all of the 3D object detection unit 121, the 3D object recognition unit 122, the I/F unit 123, and the distance measurement control unit 170 may be configured by hardware circuits that operate in cooperation with each other.

The photodetection distance measuring unit 12a performs ranging by dToF-LiDAR, and outputs a point cloud that is a set of points each having three-dimensional position information. The point cloud output from the photodetection distance measuring unit 12a is input to the signal processing unit 11a, and is supplied to the I/F unit 123 and the 3D object detection unit 121 in the signal processing unit 11a. The point cloud may include distance information and intensity information indicating the intensity of each of the TE polarized light and the TM polarized light for each point included in the point cloud.

The 3D object detection unit 121 detects a measurement point indicating a 3D object included in the supplied point cloud. Note that, in the following, in order to avoid complexity, an expression such as “detecting measurement points indicating a 3D object included in a point cloud” is described as “detecting a 3D object included in a point cloud” or the like.

The 3D object detection unit 121 detects, as a point cloud corresponding to a 3D object (referred to as a localized point cloud), a point cloud including the point cloud and having a relationship of having, for example, connection with a certain density or more from the point cloud. The 3D object detection unit 121 detects, as a localized point cloud corresponding to the 3D object, a set of point clouds localized in a certain spatial range (corresponding to the size of the target object) from the point cloud based on the extracted points. The 3D object detection unit 121 may extract a plurality of localized point clouds from the point cloud.

The 3D object detection unit 121 outputs the distance information and the intensity information regarding the localized point cloud as 3D detection information indicating a 3D detection result. In addition, the 3D object detection unit 121 may add label information indicating the 3D object corresponding to the detected localized point cloud to the region of the localized point cloud, and include the added label information in the 3D detection result.

The 3D object recognition unit 122 acquires the 3D detection information output from the 3D object detection unit 121. The 3D object recognition unit 122 performs object recognition on the localized point cloud indicated by the 3D detection information on the basis of the acquired 3D detection information. For example, in a case where the number of points included in the localized point cloud indicated by the 3D detection information is equal to or more than a predetermined number that can be used to recognize the target object, the 3D object recognition unit 122 performs object recognition processing on the localized point cloud. The 3D object recognition unit 122 estimates attribute information on the recognized object by the object recognition processing.

When the reliability of the estimated attribute information is equal to or more than a certain level, that is, when the recognition processing can be executed significantly, the 3D object recognition unit 122 acquires a recognition result for the localized point cloud as 3D recognition information. The 3D object recognition unit 122 can include the distance information, the 3D size, the attribute information, and the reliability regarding the localized point cloud in the 3D recognition information.

Note that the attribute information is information indicating attributes of the target object such as type and specific classification of the target object to which the unit belongs for each point of the point cloud and each pixel of the image as a result of the recognition processing. When the target object is a person, for example, 3D attribute information can be expressed as a unique numerical value assigned to each point of the point cloud and belonging to the person. The attribute information can further include, for example, information indicating a material of the recognized target object.

That is, the 3D object recognition unit 122 recognizes the material of the object corresponding to the localized point cloud related to the 3D detection information on the basis of the intensity information included in the 3D detection information. As a more specific example, the 3D object recognition unit 122 recognizes, for each point included in the localized point cloud, which characteristic of high reflectivity and high transmittance the material of the object corresponding to the localized point cloud has. For example, the 3D object recognition unit 122 may have characteristic data of the polarization component ratio indicating the ratio between the intensity of the TE polarized light and the intensity of the TM polarized light in advance for each type of material, and determine the material of the object corresponding to the localized point cloud on the basis of the characteristic data and the result of the object recognition.

The 3D object recognition unit 122 outputs the 3D recognition information to the I/F unit 123. Furthermore, the 3D object recognition unit 122 outputs the 3D recognition information to the distance measurement control unit 170.

The distance measurement control unit 170 is supplied with the 3D recognition information including material information from the 3D object recognition unit 122, and is supplied with mode setting information for setting the distance measuring mode from, for example, the outside of the measurement device 1a. The mode setting information is generated in accordance with a user input, for example, and is supplied to the distance measurement control unit 170. The mode setting information may be, for example, information for setting the transmission object surface distance measuring mode and the transmission destination distance measuring mode among the above-described highly reflective object distance measuring mode, transmission object surface distance measuring mode, transmission destination distance measuring mode, and normal distance measuring mode.

The distance measurement control unit 170 generates a distance measurement control signal for controlling distance measurement by the photodetection distance measuring unit 12a on the basis of the 3D recognition information and the mode setting information. For example, the distance measurement control signal may include the 3D recognition information and the mode setting information. The distance measurement control unit 170 supplies the generated distance measurement control signal to the photodetection distance measuring unit 12a.

The 3D recognition information output from the 3D object recognition unit 122 is input to the I/F unit 123. As described above, the point cloud output from the photodetection distance measuring unit 12a is also input to the I/F unit 123. The I/F unit 123 integrates and outputs the point cloud with respect to the 3D recognition information.

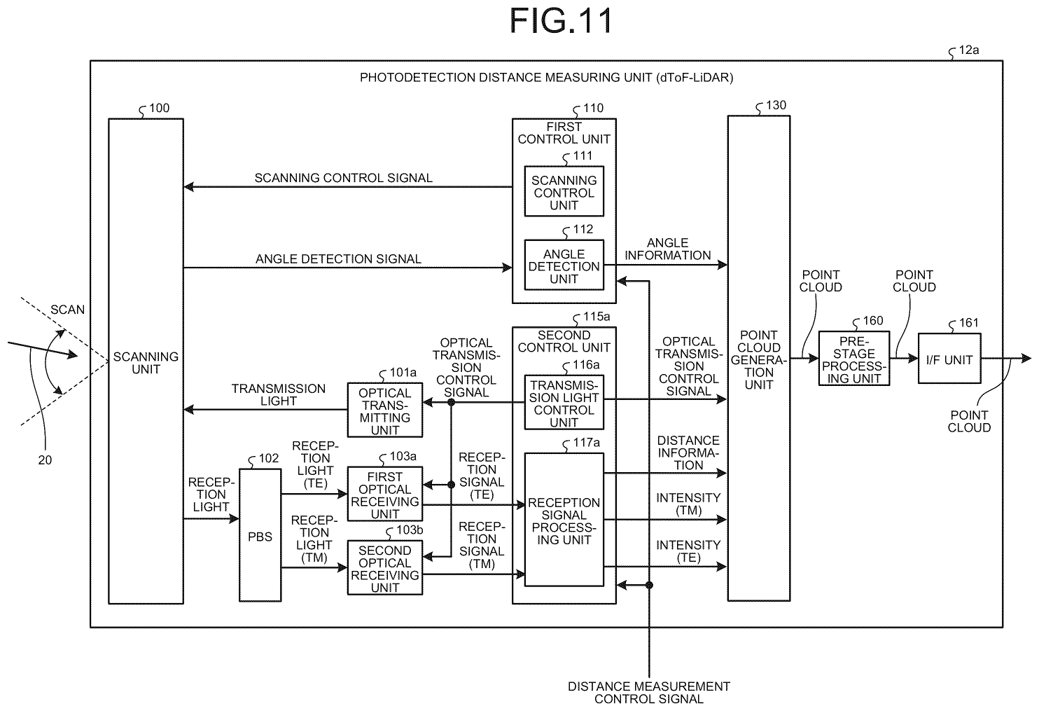

FIG. 11 is a block diagram illustrating a configuration of an example of the photodetection distance measuring unit 12a according to the first embodiment. In FIG. 11, the photodetection distance measuring unit 12a includes a scanning unit 100, an optical transmitting unit 101a, a polarization beam splitter (PBS) 102, a first optical receiving unit 103a, a second optical receiving unit 103b, a first control unit 110, a second control unit 115a, a point cloud generation unit 130, a prestage processing unit 160, and an interface (I/F) unit 161.

The distance measurement control signal output from the distance measurement control unit 170 is supplied to the first control unit 110 and the second control unit 115a. The first control unit 110 includes a scanning control unit 111 and an angle detection unit 112, and controls scanning by the scanning unit 100 according to the distance measurement control signal. The second control unit 115a includes a transmission light control unit 116a and a reception signal processing unit 117a, and performs control of transmission of laser light by the photodetection distance measuring unit 12a and processing on reception light according to the distance measurement control signal.

The optical transmitting unit 101a includes, for example, a light source such as a laser diode for emitting laser light as transmission light, an optical system for emitting light emitted by the light source, and a laser output modulation device for driving the light source. The optical transmitting unit 101a causes the light source to emit light according to an optical transmission control signal supplied from the transmission light control unit 116a to be described later, and emits pulse-modulated transmission light. The transmission light is sent to the scanning unit 100.

The transmission light control unit 116a generates, for example, a pulse signal having a predetermined frequency and duty for emitting the transmission light pulse-modulated by the optical transmitting unit 101a. On the basis of the pulse signal, the transmission light control unit 116a generates the optical transmission control signal that is a signal including information indicating the light emission timing input to the laser output modulation device included in the optical transmitting unit 101. The transmission light control unit 116a supplies the generated optical transmission control signal to the optical transmitting unit 101a, the first optical receiving unit 103a and the second optical receiving unit 103b, and the point cloud generation unit 130.

The reception light received by the scanning unit 100 is polarization-separated into TE polarized light and TM polarized light by the PBS 102, and is emitted from the PBS 102 as reception light (TE) by the TE polarized light and reception light (TM) by the TM polarized light. Therefore, the scanning unit 100 and the PBS 102 function as a receiving unit that receives reflected light obtained by reflecting laser light by the target object and polarization-separates the received reflected light into first polarized light and second polarized light.

The reception light (TE) emitted from the PBS 102 is input to the first optical receiving unit 103a. Furthermore, the reception light (TM) emitted from the PBS 102 is input to the second optical receiving unit 103b.

Note that since the configuration and operation of the second optical receiving unit 103b are similar to those of the first optical receiving unit 103a, attention is paid to the first optical receiving unit 103a below, and the description of the second optical receiving unit 103b is omitted as appropriate.

The first optical receiving unit 103a includes, for example, a light receiving unit (TE) that receives (receives light of) input reception light (TE), and a drive circuit that drives the light receiving unit (TE). As the light receiving unit (TE), for example, a pixel array in which light receiving elements such as photodiodes each constituting a pixel are arranged in a two-dimensional lattice pattern can be applied.

In the first optical receiving unit 103a, the first optical receiving unit 103a obtains a difference between the timing of the pulse included in the reception light (TE) and the light emission timing indicated in light emission timing information based on the optical transmission control signal, and outputs the difference and a signal indicating the intensity of the reception light (TE) as a reception signal (TE). Similarly, the second optical receiving unit 103b obtains a difference between the timing of the pulse included in the reception light (TM) and the light emission timing indicated in the light emission timing information, and outputs the difference and a signal indicating the intensity of the reception light (TM) as a reception signal (TM).

The reception signal processing unit 117a performs predetermined signal processing based on light speed c on the reception signals (TM) and (TE) output from the first optical receiving unit 103a and the second optical receiving unit 103b, obtains the distance to the target object, and outputs distance information indicating the distance. The reception signal processing unit 117a further outputs signal intensity (TE) indicating the intensity of the reception light (TE) and signal intensity (TM) indicating the intensity of the reception light (TM).

The scanning unit 100 transmits transmission light transmitted from the optical transmitting unit 101a at an angle according to a scanning control signal supplied from the scanning control unit 111, and receives incident light as reception light. In a case where, for example, a biaxial mirror scanning device is applied as a scanning mechanism of the transmission light in the scanning unit 100, the scanning control signal is, for example, a drive voltage signal applied to each axis of the biaxial mirror scanning device.

The scanning control unit 111 generates a scanning control signal for changing the transmission/reception angle by the scanning unit 100 within a predetermined angular range, and supplies the scanning control signal to the scanning unit 100. The scanning unit 100 can execute scanning in a certain range by the transmission light according to the supplied scanning control signal.

The scanning unit 100 includes a sensor that detects an emission angle of the transmission light to be emitted, and outputs an angle detection signal indicating the emission angle of the transmission light detected by the sensor. The angle detection unit 112 obtains a transmission/reception angle on the basis of the angle detection signal output from the scanning unit 100, and generates angle information indicating the obtained angle.

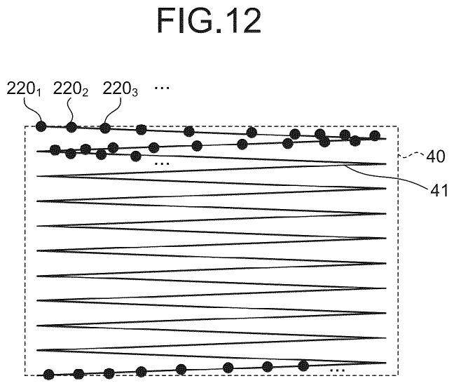

FIG. 12 is a schematic diagram schematically illustrating an example of scanning of transmission light by the scanning unit 100. The scanning unit 100 performs scanning according to a predetermined number of scanning lines 41 within a scanning range 40 corresponding to a predetermined angular range. The scanning lines 41 each correspond to one trajectory obtained by scanning between a left end and a right end of the scanning range 40. The scanning unit 100 scans between an upper end and a lower end of the scanning range 40 following the scanning line 41 according to the scanning control signal.

At this time, in accordance with the scanning control signal, the scanning unit 100 sequentially and discretely changes the emission point of the laser light along the scanning line 41 at, for example, constant time intervals (point rates) like points 220₁, 220₂, 220₃, . . . , for example. At this time, near turning points at the left end and the right end of the scanning range 40 of the scanning line 41, the scanning speed by the biaxial mirror scanning device decreases. Thus, the points 220₁, 220₂, 220₃, . . . are not arranged in a lattice pattern in the scanning range 40. Note that the optical transmitting unit 101 may emit laser light one or more times to one emission point in accordance with the optical transmission control signal supplied from the transmission light control unit 116.

Returning to the description of FIG. 11, the point cloud generation unit 130 generates a point cloud on the basis of the angle information generated by the angle detection unit 112, the optical transmission control signal supplied from the transmission light control unit 116a, and each piece of measurement information supplied from the reception signal processing unit 117a. More specifically, the point cloud generation unit 130 specifies one point in the space by the angle and the distance on the basis of the angle information and the distance information included in the measurement information. The point cloud generation unit 130 acquires a point cloud as a set of the specified points under a predetermined condition. The point cloud generation unit 130 may obtain, for example, luminance of each specified point on the basis of the signal intensity (TE) and the signal intensity (TM) included in the measurement information, and add the obtained luminance to the point cloud. That is, the point cloud includes information indicating a distance (position) by the three-dimensional information for each point included in the point cloud, and can further include information indicating luminance.

The prestage processing unit 160 performs predetermined signal processing such as format conversion on the point cloud acquired by the point cloud generation unit 30. The point cloud subjected to the signal processing by the prestage processing unit 160 is output to the outside of the photodetection distance measuring unit 12a via the I/F unit 161. The point cloud output from the I/F unit 161 includes distance information as three-dimensional information at each point included in the point cloud.

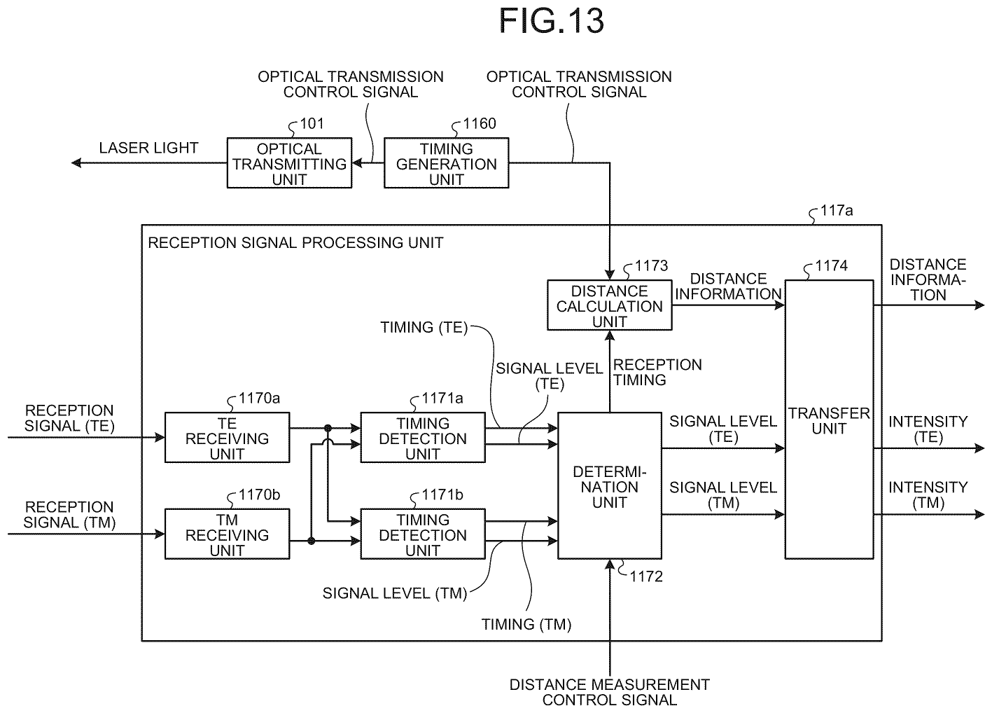

FIG. 13 is a block diagram illustrating a configuration of an example of the reception signal processing unit 117a according to the first embodiment. Note that, in FIG. 13, a timing generation unit 1160 is included in the transmission light control unit 116 in FIG. 11, and generates a timing signal indicating a timing at which the optical transmitting unit 101a emits transmission light. The timing signal is included in, for example, the optical transmission control signal and supplied to the optical transmitting unit 101 and a distance calculation unit 1173.

In FIG. 13, the reception signal processing unit 117a includes a TE receiving unit 1170a, a TM receiving unit 1170b, a timing detection unit 1171a, a timing detection unit 1171b, a determination unit 1172, the distance calculation unit 1173, and a transfer unit 1174.

The reception signal (TE) output from the first optical receiving unit 103a is input to the TE receiving unit 1170a. Similarly, the reception signal (TM) output from the second optical receiving unit 103b is input to the TM receiving unit 1170b.

The TE receiving unit 1170a performs noise processing on the input reception signal (TE) to suppress a noise component. With respect to the reception signal (TE) in which the noise component is suppressed, the TE receiving unit 1170a classifies a difference between the timing of a pulse included in the reception light (TE) and the light emission timing indicated by the light emission timing information on the basis of a class (bins) and generates a histogram (referred to as a histogram (TE)). The TE receiving unit 1170a passes the generated histogram (TE) to the timing detection unit 1171a. The timing detection unit 1171a analyzes the histogram (TE) passed from the TE receiving unit 1170a, and sets, for example, a time corresponding to a bin having the highest frequency as a timing (TE), and sets a frequency of the bin as a signal level (TE). The timing detection unit 1171a passes the timing (TE) and the signal level (TE) obtained by the analysis to the determination unit 1172.

Similarly, the TM receiving unit 1170b performs noise processing on the input reception signal (TM), and generates the histogram as described above on the basis of the reception signal (TM) in which the noise component is suppressed. The TM receiving unit 1170b passes the generated histogram to the timing detection unit 1171b. The timing detection unit 1171b analyzes the histogram passed from the TM receiving unit 1170b, and sets, for example, a time corresponding to a bin having the highest frequency as a timing (TM), and sets a frequency of the bin as a signal level (TM). The timing detection unit 1171b passes the timing (TM) and the signal level (TM) obtained by the analysis to the determination unit 1172.

The determination unit 1172 obtains a reception timing used by the distance calculation unit 1173 to calculate the distance on the basis of the timing (TE) and the signal level (TE) detected by the timing detection unit 1171a and the timing (TM) and the signal level (TM) detected by the timing detection unit 1171b.

More specifically, the determination unit 1172 compares the signal level (TE) with the signal level (TM), and detects characteristics of a material of a distance measurement target on the basis of the comparison result. For example, the determination unit 1172 obtains a ratio (polarization ratio) between the signal level (TE) and the signal level (TM), and determines whether or not the distance measurement target is a highly reflective object. The determination unit 1172 may determine whether or not the distance measurement target is a high transmittance object on the basis of the signal level (TE) and the signal level (TM). In other words, it can be said that the determination unit 1172 makes a determination on the basis of a comparison result obtained by comparing the intensity of the first polarized light with the intensity of the second polarized light.

The determination unit 1172 determines which of the plurality of peaks detected for the signal level (TE) and the signal level (TM) is employed as the reception timing according to the characteristic of the detected material. That is, the determination unit 1172 functions as a determination unit that determines the light reception timing of the reflected light on the basis of the first polarized light and the second polarized light.

The distance calculation unit 1173 passes the calculated distance information to the transfer unit 1174. Furthermore, the determination unit 1172 passes the signal level (TE) and the signal level (TM) to the transfer unit 1174. The transfer unit 1174 outputs the distance information and outputs the signal level (TE) and the signal level (TM) passed from the determination unit 1172 as the intensity (TE) and the intensity (TM), respectively.

The 3D object recognition unit 122 described above performs the object recognition processing on the basis of the point cloud obtained from the distance information calculated using the reception timing according to a determination result on the basis of the TE polarized light and the TM polarized light by the determination unit 1172. Therefore, the 3D object recognition unit 122 functions as a recognition unit that performs object recognition for the target object on the basis of the first polarized light and the second polarized light.

### 3-2. Processing According to First Embodiment

Next, processing according to the first embodiment will be described.

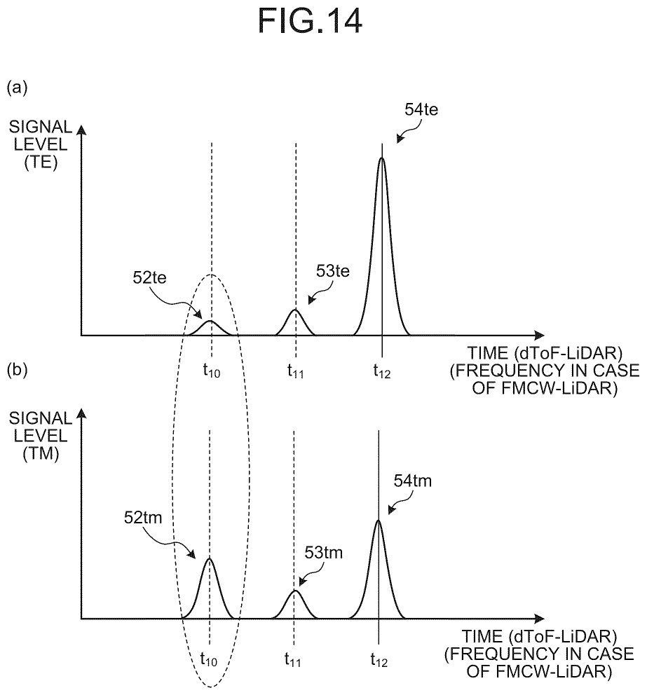

FIG. 14 is a schematic diagram for describing processing by the timing detection unit 1171a and the timing detection unit 1171b. In FIG. 14, section (a) illustrates processing in the timing detection unit 1171a, and section (b) illustrates processing examples in the timing detection unit 1171b. In sections (a) and (b), the vertical axis represents each signal level, and the horizontal axis represents time. Note that, in a case where EMCW-LiDAR is used for distance measurement, the horizontal axis represents a frequency.

For the sake of explanation, in FIG. 14, it is assumed that time t₁₀ corresponds to reception light by a material having high reflectivity (reflective object), and times t₁₁ and t₁₂ correspond to reception light by a material having low reflectivity.

Section (a) of FIG. 14 is taken as an example, and it is assumed that the TE receiving unit 1170a obtains a signal as illustrated by analyzing the histogram generated on the basis of the reception signal (TE). The timing detection unit 1171a detects a peak from the signal of the analysis result and obtains the signal level of the peak and the timing of the peak. In the example in section (a) of FIG. 14, the timing detection unit 1171a detects peaks 52te, 53te, and 54te at times t₁₀, t₁₁, and t₁₂, respectively.

Note that, in a case where FMCW-LiDAR with continuously frequency-modulated laser light is used as the distance measurement method in the photodetection distance measuring unit 12a, the timing of the peak can be obtained as frequency information. Taking FIG. 14 as an example, in a case where FMCW-LiDAR is used, the peaks 52te, 53te, and 54te are detected at frequencies f₁₀, f₁₁, and f₁₂, respectively.

Similarly in section (b) of FIG. 14, the timing detection unit 1171b detects a peak from the illustrated signal obtained from the analysis result of the reception signal (TM) by the TM receiving unit 1170b, and obtains the signal level of the peak and the timing of the peak. In the example of section (b) of FIG. 14, the timing detection unit 1171b detects peaks 52tm, 53tm, and 54tm at times t₁₀, t₁₁, and t₁₂, respectively, which are the same as those in section (a).

In the example of sections (a) and (b) of FIG. 14, the relationship among the signal levels at the peaks at times t₁₀, t₁₁, and t₁₂ is as follows.
t₁₀: peak 52te<peak 52tm
t₁₁ peak 53te≈peak 53tm
t₁₂: peak 54te>peak 54tm

The timing detection unit 1171a passes the information indicating each timing detected in this manner and the information indicating the signal level of each peak to the determination unit 1172. Similarly, the timing detection unit 1171b passes the information indicating each timing detected in this manner and the information indicating the signal level of each peak to the determination unit 1172.

On the basis of the distance measurement control signal, respective pieces of timing information supplied from the timing detection unit 1171a and the timing detection unit 1171b, and respective pieces of signal level information, the determination unit 1172 determines which light reception timing the distance calculation unit 1173 uses for distance calculation among light reception timings indicated by the respective pieces of timing information. As described above, in scattering of light on the object surface, the polarization component ratio of the reflected light has a characteristic corresponding to the material of the object. The determination unit 1172 divides the signal level (TM) by the signal level (TE) by matching frequency axes to obtain the polarization component ratio of the TM polarized light and the TE polarized light.

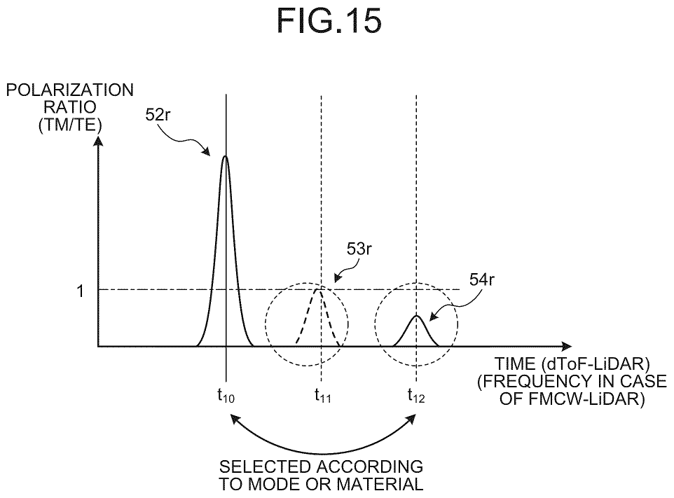

FIG. 15 is a schematic diagram illustrating an example of a result of obtaining the polarization component ratio between TM polarized light and TE polarized light. In FIG. 15, the vertical axis represents a polarization ratio (TM/TE) in a case where the signal level (TM) is divided by the signal level (TE), and the horizontal axis represents time, and each signal level in section (b) of FIG. 14 is divided by each signal level in section (a). In the example of FIG. 15, a peak of the polarization ratio (TM/TE) is obtained at each of times t₁₀, t₁₁, and t₁₂ corresponding to respective peaks of the signal level in sections (a) and (b) of FIG. 14. Note that, in a case where FMCW-LiDAR is used for distance measurement, the horizontal axis represents a frequency.

Which one of the timings (time t₁₀, t₁₁ and t₁₂) corresponding to peaks 52r, 53r, and 54r, respectively, illustrated in FIG. 15 is employed is selected according to the mode setting information included in the distance measurement control signal and the material of the target object to be subjected to distance measurement.

As described above, when the target is an object of a material having high reflectivity, the polarization ratio obtained by dividing the intensity of the TM polarized light by the intensity of the TE polarized light tends to increase. Thus, in a case where it is desired to perform distance measurement on the reflective object, the determination unit 1172 may determine the timing of time t when the polarization ratio (TM/TE)>1 (the timing corresponding to the frequency f in the case of FMCW-LiDAR) as the light reception timing used for distance measurement. Note that the determination unit 1172 may further provide a predetermined threshold value larger than 1 for the condition of polarization ratio (TM/TE)>1 and perform the determination under the condition of polarization ratio (TM/TE)>threshold value (>1).

In the example of FIG. 15, the peak 52r satisfying the condition of polarization ratio (TM/TE)>threshold value (>1) is determined to be the peak due to the reflective object, and time t₁₀ corresponding to the peak 52r is employed as the timing used for the distance measurement. On the other hand, the other peaks 53r and 54r that do not satisfy the condition are determined not to be peaks due to a reflective object, and are processed as noise, for example. Therefore, times t₁₁ and t₁₂ respectively corresponding thereto are not employed as light reception timings used for distance measurement.

The determination unit 1172 passes time t₁₀ corresponding to the peak 54r determined to satisfy the condition to the distance calculation unit 1173 as the light reception timing at which the distance measurement is performed. Furthermore, to the distance calculation unit 1173, the optical transmission control signal is passed from the timing generation unit 1160 included in the transmission light control unit 116. The distance calculation unit 1173 calculates the distance on the basis of the light reception timing and the optical transmission control signal.

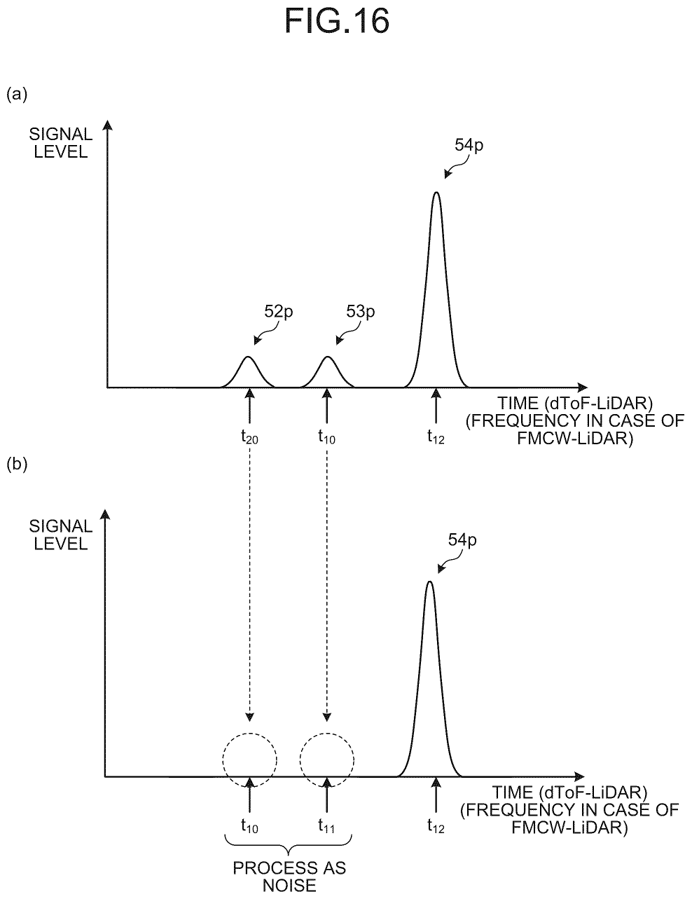

FIG. 16 is a schematic diagram for describing an example of processing according to the existing technology. In FIG. 16, the vertical axis represents the signal level based on a light reception signal, and the horizontal axis represents time. Furthermore, FIG. 16 illustrates a case where the same range as that in FIG. 14 described above is scanned.

In the existing technology, processing based on TE polarized light and TM polarized light obtained by polarization separation of reception light is not performed. Thus, among peaks 52p, 53p, and 54p corresponding to times t₁₀, t₁₁, and t₁₂, respectively, illustrated in section (a) of FIG. 16, the peaks 52p and 53p having a low signal level are subjected to noise processing, and time t₁₂ corresponding to the peak 54p having a high signal level is determined as the timing to be used for distance measurement. Therefore, it is difficult to measure the distance to the target reflective object.

On the other hand, according to the first embodiment, as described above, in the distance measurement using the LiDAR, the light reception timing used for the distance measurement is determined on the basis of the TE polarized light and the TM polarized light obtained by polarization-separating the reception light. Thus, it is possible to perform distance measurement according to the material of the distance measurement target.

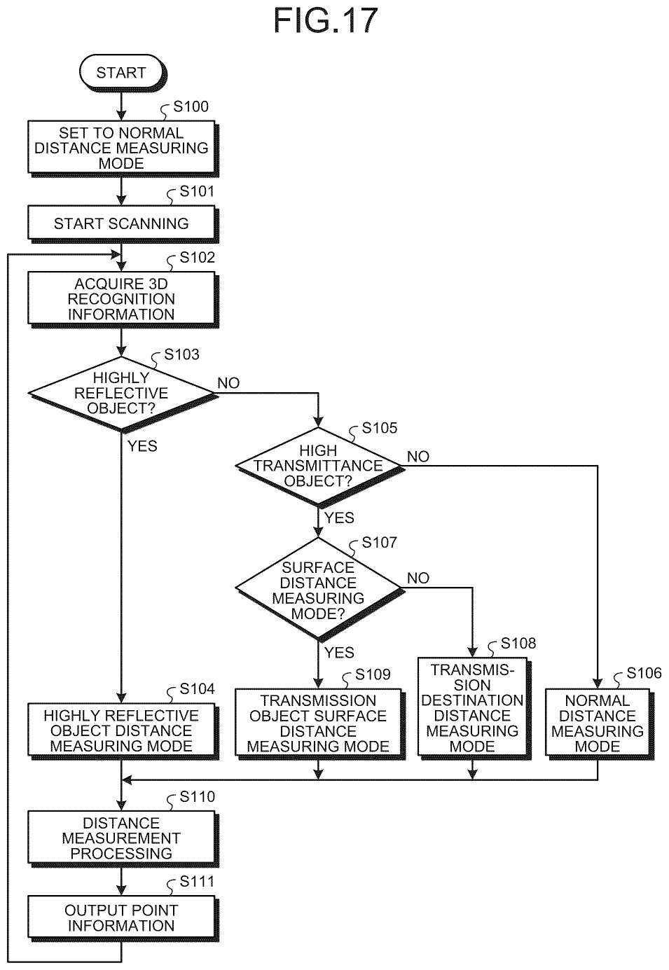

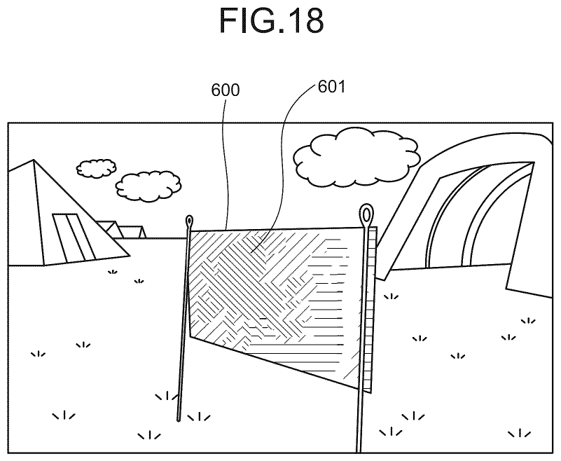

FIG. 17 is a flowchart illustrating an example of distance measurement processing according to the first embodiment. In step S100, in the measurement device 1a, the distance measurement control unit 170 sets the distance measuring mode to the normal distance measuring mode. The distance measurement control unit 170 passes the distance measurement control signal including the mode setting information indicating the distance measuring mode to the photodetection distance measuring unit 12a. In the next step S101, the photodetection distance measuring unit 12a starts scanning with laser light in response to the distance measurement control signal and acquires point cloud information.

In the measurement device 1a, the 3D object detection unit 121 performs object detection on the basis of the point cloud information acquired by the photodetection distance measuring unit 12a, and acquires the 3D detection information. The 3D object recognition unit 122 performs the object recognition processing on the basis of the 3D detection information acquired by the 3D object detection unit 121 to acquire the 3D recognition information. The 3D recognition information is passed to the I/F unit 123 and the distance measurement control unit 170.

In the next step S102, the reception signal processing unit 117a acquires the 3D recognition information included in the distance measurement control signal supplied from the distance measurement control unit 170 to the second control unit 115a. In the next step S103, the determination unit 1172 in the reception signal processing unit 117a determines whether or not one point (hereinafter, a target point) to be a target of distance measurement from the point cloud has a characteristic of a highly reflective object on the basis of the 3D recognition information. For example, the determination unit 1172 may select the target point from the localized point cloud corresponding to an object designated in advance as a recognition target in the point cloud on the basis of the 3D recognition information, and perform determination.

When the determination unit 1172 determines that the target point has the characteristic of the highly reflective object (step S103, “Yes”), the processing proceeds to step S104.

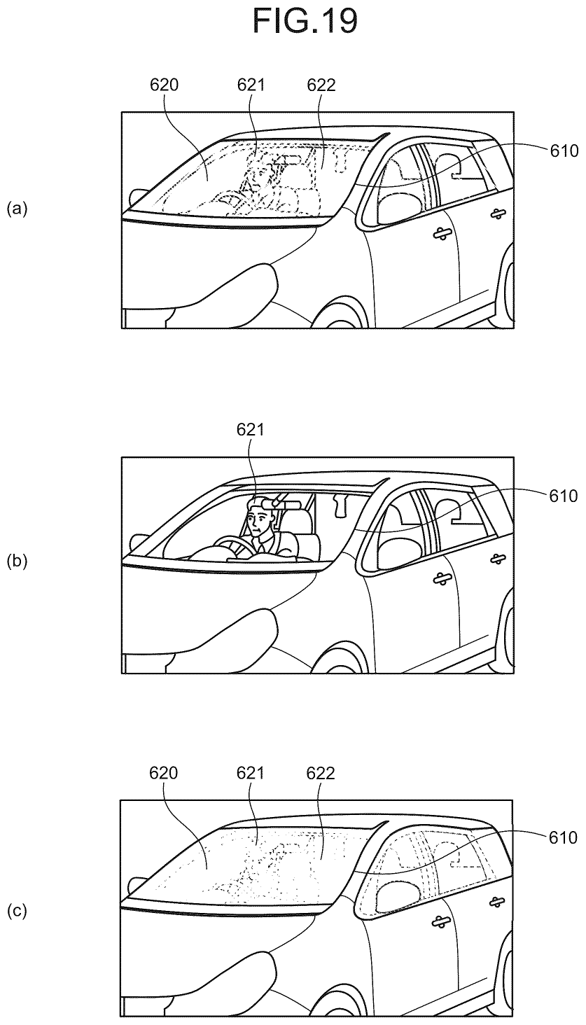

In step S104, the determination unit 1172 sets the distance measuring mode to the highly reflective object distance measuring mode. FIG. 18 is a schematic diagram illustrating an example of a highly reflective object. In FIG. 18, it is assumed that a target object 600 having high reflectivity (for example, a metal plate having a glossy surface) is installed outdoors, and the measurement device 1a is installed on the front side of the target object 600 (not illustrated). Furthermore, it is assumed that the target object 600 is installed at an angle of 45° with the right end side as the front side with respect to the measurement device 1a, and a virtual image 601 of an object (not illustrated) on the left side is reflected in the target object 600.

In this case, as described with reference to FIG. 6, the measurement device 1a may erroneously detect a point included in the virtual image 601 as a target point corresponding to the object of the virtual image 601 at the distance in a depth direction with respect to the target object 600. Thus, the determination unit 1172 determines whether or not the target point in the target object 600 has high reflectivity on the basis of the polarization ratio (TM/TE), and selects the light reception timing used for distance measurement from a plurality of peaks detected for the target point on the basis of the determination result as described with reference to FIGS. 14 and 15. The determination unit 1172 passes the selected light reception timing to the distance calculation unit 1173.

On the other hand, when the determination unit 1172 determines in step S103 that the target point does not have the characteristic of the highly reflective object (step S103, “No”), the processing proceeds to step S105.

In step S105, the determination unit 1172 determines whether or not the target point is a point by a high transmittance object. For example, the determination unit 1172 may determine whether or not the target point has high transparency on the basis of the 3D recognition information included in the distance measurement control signal.

FIG. 19 is a schematic diagram illustrating an example of the high transmittance object. In FIG. 19, sections (a) to (c) illustrate a windshield 610 of a vehicle as an example of a high transmittance object. Section (a) in FIG. 19 illustrates the windshield 610 that appears in a human eye or is captured by a general camera, for example. In this drawing, a driver 621 can be observed through the windshield 610, and reflections 620 and 622 of the surroundings with respect to the windshield 610 can be observed.

For example, in a case where the 3D recognition information includes information regarding a region estimated to be the windshield 610 by the 3D object recognition unit 122 and the target point is included in the region, the determination unit 1172 can determine that the target point is a point by a high transmittance object.

When the determination unit 1172 determines that the target point is not a point by the high transmittance object in step S105 (step S105, “No”), the processing proceeds to step S106. In step S106, the determination unit 1172 sets the distance measuring mode to the normal distance measuring mode. For example, the determination unit 1172 passes, to a distance calculation unit 174, the timing corresponding to the peak having the maximum signal level among the detected peaks as the light reception timing.

On the other hand, when the determination unit 1172 determines that the target point is a point by the high transmittance object in step S105 (step S105, “Yes”), the processing proceeds to step S107. In step S107, the determination unit 1172 determines whether or not the surface distance measuring mode is designated. Note that a surface distance measuring mode is set, for example, in accordance with the mode setting information corresponding to a user input.

When determining that the surface distance measuring mode is not designated (step S107, “No”), the determination unit 1172 shifts the processing to step S108 and sets the distance measuring mode to the transmission destination distance measuring mode. On the other hand, when determining that the surface distance measuring mode is designated (step S107, “Yes”), the determination unit 1172 shifts the processing to step S109 and sets the distance measuring mode to the transmission object surface distance measuring mode.

The transmission destination distance measuring mode is a distance measuring mode in which distance measurement for an object ahead of the object recognized as a high transmittance object as viewed from the measurement device 1a is performed. For example, in the transmission destination distance measuring mode, as illustrated in section (b) of FIG. 19, distance measurement for the driver 621 ahead of the windshield 610 as viewed from the measurement device 1a is performed. On the other hand, as illustrated in section (c) of FIG. 19, in the transmission object surface distance measuring mode, distance measurement is performed on the windshield 610 itself recognized as a high transmittance object.

In the transmission object surface distance measuring mode, distance measurement is performed with respect to the surface (for example, the windshield 610) of the high transmittance object, whereas in the transmission destination distance measuring mode, distance measurement is performed for an object (for example, the driver 621) at a destination that has transmitted through the windshield 610. Thus, the determination unit 1172 can determine whether the target point is a point corresponding to the surface of the high transmittance object or a point corresponding to the object ahead of the high-transmittance object on the basis of the distances (frequencies) corresponding to the plurality of detected peaks.

Taking FIG. 15 as an example, while the peak 52r is excluded because it is a peak due to a highly reflective object, it can be determined that the peak 53r is a peak of a high transmittance object, and the peak 54r detected at a longer distance than the peak 53r is the peak of the transmission destination. The determination unit 1172 passes the light reception timing corresponding to the determined peak to the distance calculation unit 1173.

When the processing of step S104, step S106, step S108, or step S109 ends, the processing proceeds to step S110. In step S110, the distance calculation unit 1173 measures the distance to the target point according to the light reception timing passed from the determination unit 1172 in step S104, step S106, step S108, or step S109. The distance calculation unit 1173 passes the distance information obtained by distance measurement to the transfer unit 1174.

In the next step S111, the transfer unit 1174 outputs the distance information passed from the distance calculation unit 1173 as point information regarding the target point. The transfer unit 1174 may further include the intensity (TE) and the intensity (TM) corresponding to the target point in the point information and output the point information.

After the processing of step S111, the measurement device 1a returns the processing to step S102, and executes the processing of step S102 and subsequent steps with one unprocessed point in the point cloud as a new target point.

As described above, in the first embodiment, in the distance measurement using the LiDAR, the light reception timing used for the distance measurement is determined on the basis of the TE polarized light and the TM polarized light obtained by polarization separation of the reception light. Further, the light reception timing used for distance measurement is also determined using the 3D recognition information. Thus, the light reception timing used for distance measurement can be determined according to whether the material of the distance measurement target is a highly reflective object or a high transmittance object, and distance measurement according to the material of the distance measurement target can be performed.

Furthermore, according to the first embodiment, in a case where the distance measurement target is a high transmittance object, it is possible to select whether to perform distance measurement for the surface of the high transmittance object or to perform distance measurement for an object ahead of the high transmittance object depending on the mode setting, and it is possible to perform the distance measurement more flexibly.

### 4. MODIFICATION OF FIRST EMBODIMENT

Next, a modification of the first embodiment will be described. A modification of the first embodiment is an example in which FMCW-LiDAR among LiDAR is applied as a distance measuring method. In the FMCW-LiDAR, the target object is irradiated with continuously frequency-modulated laser light, and distance measurement is performed on the basis of emitted light and reflected light thereof.

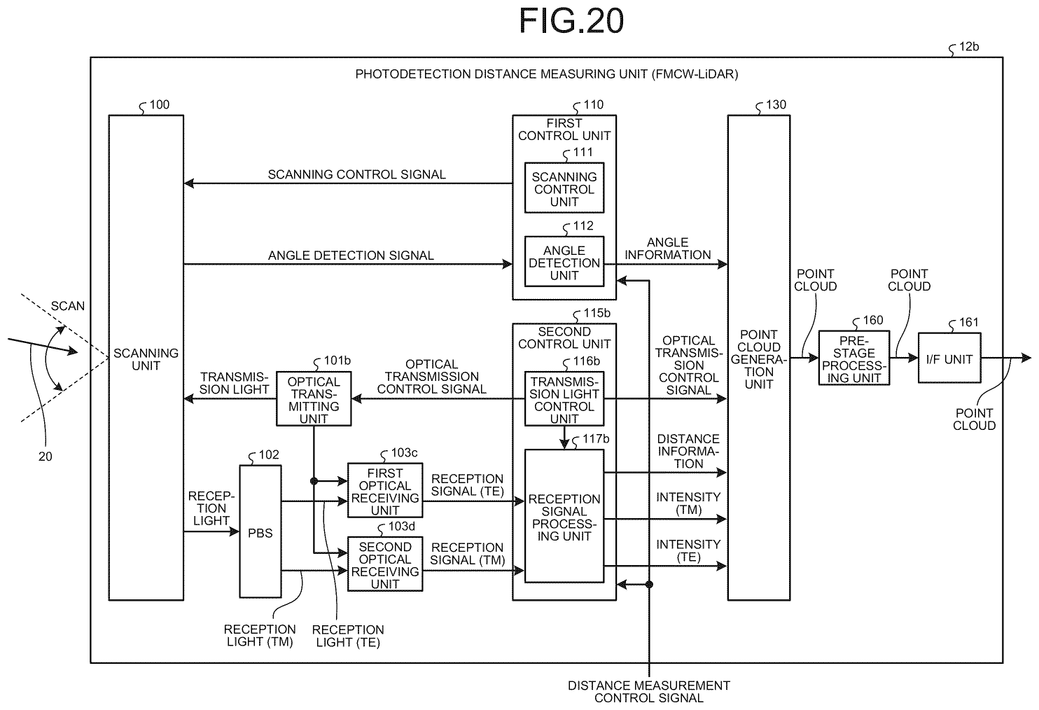

FIG. 20 is a block diagram illustrating a configuration of an example of a photodetection distance measuring unit 12b according to a modification of the first embodiment. Note that the measurement device according to the modification of the first embodiment is common to the configuration of the measurement device 1a except that the photodetection distance measuring unit 12a in the measurement device 1a illustrated in FIG. 10 is replaced with the photodetection distance measuring unit 12b illustrated in FIG. 20, and thus detailed description thereof will be omitted here. Furthermore, here, description will be given focusing on a portion different from that in FIG. 11 described above in FIG. 20, and description of a portion common to FIG. 20 will be appropriately omitted.

In the photodetection distance measuring unit 12b illustrated in FIG. 20, an optical transmitting unit 101b causes a light source to emit light in accordance with the optical transmission control signal supplied from a transmission light control unit 116b to be described later, and emits transmission light by chirp light whose frequency linearly changes within a predetermined frequency range with the lapse of time. The transmission light is sent to the scanning unit 100, and is sent to a first optical receiving unit 103c and a second optical receiving unit 103d as local light.

The transmission light control unit 116 generates a signal whose frequency linearly changes (for example, increases) within a predetermined frequency range as time elapses. Such a signal whose frequency linearly changes within a predetermined frequency range with the lapse of time is referred to as a chirp signal. On the basis of the chirp signal, the transmission light control unit 116b generates the optical transmission control signal as a modulation synchronization timing signal input to the laser output modulation device included in the optical transmitting unit 101. The transmission light control unit 116b supplies the generated optical transmission control signal to the optical transmitting unit 101b and the point cloud generation unit 130.

The reception light received by the scanning unit 100 is polarization-separated into TE polarized light and TM polarized light by the PBS 102, and is emitted from the PBS 102 as reception light (TE) by the TE polarized light and reception light (TM) by the TM polarized light.

The reception light (TE) emitted from the PBS 102 is input to the first optical receiving unit 103c. Further, the reception light (TM) emitted from the PBS 102 is input to the second optical receiving unit 103d.

Note that since the configuration and operation of the second optical receiving unit 103d are similar to those of the first optical receiving unit 103c, attention is paid to the first optical receiving unit 103c, and the description of the second optical receiving unit 103d will be appropriately omitted.

The first optical receiving unit 103c further includes a combining unit (TE) that combines the reception light (TE) having been input with the local light transmitted from the optical transmitting unit 101b. If the reception light (TE) is reflected light from the target object of the transmission light, the reception light (TE) is a signal delayed according to the distance to the target object with respect to the local light, and a combined signal obtained by combining the reception light (TE) and the local light becomes a signal (beat signal) of a constant frequency.

The first optical receiving unit 103c and the second optical receiving unit 103d output signals corresponding to the reception light (TE) and the reception light (TM), respectively, as the reception signal (TE) and the reception signal (TM).

The reception signal processing unit 117b performs signal processing such as fast Fourier transform on the reception signal (TM) and the reception signal (TE) output from the first optical receiving unit 103c and the second optical receiving unit 103d, respectively. The reception signal processing unit 117b obtains the distance to the target object by this signal processing, and outputs distance information indicating the distance. The reception signal processing unit 117 further outputs the signal intensity (TE) indicating the intensity of the reception signal (TE) and the signal intensity (TM) indicating the intensity of the reception signal (TM).

The scanning unit 100 transmits transmission light transmitted from the optical transmitting unit 101b at an angle according to a scanning control signal supplied from the scanning control unit 111, and receives incident light as reception light. Since the processing in the scanning unit 100 and the first control unit 110 is similar to the processing described with reference to FIG. 11, the description thereof will be omitted here. Furthermore, the scanning of the transmission light by the scanning unit 100 is also similar to the processing described with reference to FIG. 12, and thus the description thereof will be omitted here.

The point cloud generation unit 130 generates a point cloud on the basis of the angle information generated by the angle detection unit 112, the optical transmission control signal supplied from the transmission light control unit 116b, and each piece of measurement information supplied from the reception signal processing unit 117b. Since the processing by the point cloud generation unit 130 is similar to the processing described with reference to FIG. 11, the description thereof will be omitted here.

Similarly to the reception signal processing unit 117a described with reference to FIG. 13, the reception signal processing unit 117b includes the TE receiving unit 1170a, the TM receiving unit 1170b, the timing detection unit 1171a, the timing detection unit 1171b, the determination unit 1172, the distance calculation unit 1173, and the transfer unit 1174. Hereinafter, processing in the reception signal processing unit 117b will be described with reference to FIG. 13.

In the reception signal processing unit 117b, the reception signal (TE) output from the first optical receiving unit 103c is input to the TE receiving unit 1170a. Similarly, the reception signal (TM) output from the second optical receiving unit 103d is input to the TM receiving unit 1170b.

The TE receiving unit 1170a performs noise processing on the input reception signal (TE) to suppress a noise component. The TE receiving unit 1170a further performs fast Fourier transform processing on the reception signal (TE) in which the noise component is suppressed, analyzes the reception signal (TE), and outputs an analysis result. On the basis of the signal output from the TE receiving unit 1170a, the timing detection unit 1171a detects the timing (TE) of the peak of the signal due to the TE polarized light, and detects the signal level (TE) at the timing (TE).

Similarly, the TM receiving unit 1170b detects the timing (TM) of the peak of the signal by the TM polarized light and the signal level (TM) at the timing (TM) on the basis of the input reception signal (TM).

The determination unit 1172 obtains the reception timing used by the distance calculation unit 1173 to calculate the distance on the basis of the timing (TE) and the signal level (TE) detected by the timing detection unit 1171a and the timing (TM) and the signal level (TM) detected by the timing detection unit 1171b.

Since the processing by the determination unit 1172 and the distance calculation unit 1173 is similar to the processing by the determination unit 1172 and the distance calculation unit 1173 described with reference to FIGS. 13 to 19 and the like in the first embodiment, the description thereof will be omitted here.

As described above, the technology according to the present disclosure can also be applied to a measurement device using the FMCW-LiDAR for distance measurement.

### 5. SECOND EMBODIMENT

Next, a second embodiment of the present disclosure will be described. The second embodiment is an example in which, in the sensor unit 10a according to the first embodiment described above, an imaging device is provided in addition to the photodetection distance measuring unit 12a, and object recognition is performed using a point cloud acquired by the photodetection distance measuring unit 12a and a captured image captured by the imaging device to obtain recognition information.

An imaging device capable of acquiring a captured image having information of each color of red (R), green (G), and blue (B) generally has a much higher resolution than the photodetection distance measuring unit 12a by FMCW-LiDAR. Therefore, by performing the recognition processing using the photodetection distance measuring unit 12a and the imaging device, the detection and recognition processing can be executed with higher accuracy as compared with a case where the detection and recognition processing is performed using only the point cloud information by the photodetection distance measuring unit 12a.

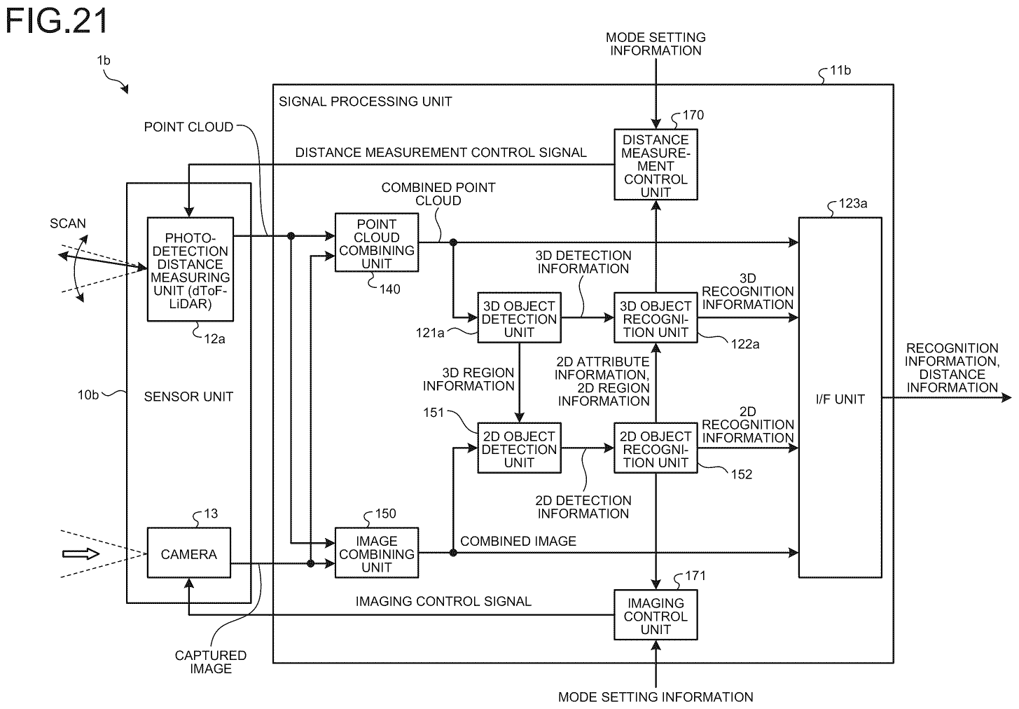

FIG. 21 is a block diagram illustrating a configuration of an example of a measurement device according to the second embodiment. Note that, in the following description, description of a part common to FIG. 10 described above will be omitted as appropriate.

In FIG. 21, a measurement device 1b according to the second embodiment includes a sensor unit 10b and a signal processing unit 11b.

The sensor unit 10b includes the photodetection distance measuring unit 12a and a camera 13. The camera 13 is an imaging device including an image sensor capable of acquiring a captured image having information (hereinafter, the color information is appropriately referred to as color information) of each color of RGB described above, and can control the angle of view, exposure, diaphragm, zoom, and the like according to an imaging control signal supplied from the outside.

The image sensor includes, for example, a pixel array in which pixels that output signals corresponding to the received light are arranged in a two-dimensional lattice pattern, and a drive circuit for driving each pixel included in the pixel array.

Note that FIG. 21 illustrates that the sensor unit 10b outputs a point cloud by the photodetection distance measuring unit 12a by dToF-LiDAR, but this is not limited to this example. That is, the sensor unit 10b may include the photodetection distance measuring unit 12b that outputs a point cloud by FMCW-LiDAR.

In FIG. 21, the signal processing unit 11b includes a point cloud combining unit 140, a 3D object detection unit 121a, a 3D object recognition unit 122a, an image combining unit 150, a two-dimensions (2D) object detection unit 151, a 2D object recognition unit 152, and an I/F unit 123a.

The point cloud combining unit 140, the 3D object detection unit 121a, and the 3D object recognition unit 122a perform processing related to the point cloud information. Furthermore, the image combining unit 150, the 2D object detection unit 151, and the 2D object recognition unit 152 perform processing related to the captured image.

The point cloud combining unit 140 acquires a point cloud from the photodetection distance measuring unit 12a and acquires a captured image from the camera 13. The point cloud combining unit 140 combines color information and other information on the basis of the point cloud and the captured image to generate a combined point cloud that is a point cloud obtained by adding new information and the like to each measurement point of the point cloud.

More specifically, the point cloud combining unit 140 refers to pixels of the captured image corresponding to angular coordinates of each measurement point in the point cloud by coordinate system conversion, and acquires color information representing the point for each measurement point. The measurement point corresponds to the point at which the reflected light is received for each of the points 220₁, 220₂, 220₃, . . . described with reference to FIG. 12. The point cloud combining unit 140 adds the acquired color information of each measurement point to the measurement information of each measurement point. The point cloud combining unit 140 outputs a combined point cloud in which each measurement point has 3D coordinate information, speed information, luminance information, and color information.

Note that the coordinate system conversion between the point cloud and the captured image is preferably performed, for example, after calibration processing based on the positional relationship between the photodetection distance measuring unit 12a and the camera 13 is performed in advance and the calibration result is reflected on the angular coordinates of a speed point cloud and the coordinates of the pixel in the captured image.

The processing by the 3D object detection unit 121a corresponds to the 3D object detection unit 121 described with reference to FIG. 10, acquires the combined point cloud output from the point cloud combining unit 140, and detects the measurement point indicating the 3D object included in the acquired combined point cloud. The 3D object detection unit 121a extracts a point cloud of measurement points indicating 3D objects detected from the combined point cloud as a localized point cloud.

The 3D object detection unit 121a outputs the localized point cloud and the distance information and intensity information on the localized point cloud as the 3D detection information. The 3D detection information is passed to the 3D object recognition unit 122a and a 2D object detection unit 151 described later. At this time, the 3D object detection unit 121a may add label information indicating a 3D object corresponding to the localized point cloud to the region of the detected localized point cloud, and include the added label information in the 3D detection result.

The 3D object recognition unit 122a acquires the 3D detection information output from the 3D object detection unit 121a. Furthermore, the 3D object recognition unit 122a acquires 2D region information and 2D attribute information output from the 2D object recognition unit 152 described later. The 3D object recognition unit 122a performs object recognition on the localized point cloud on the basis of the acquired 3D detection information, the 2D region information acquired from the 2D object recognition unit 152, and the 2D attribute information.

On the basis of the 3D detection information and the 2D region information, in a case where the number of points included in the localized point cloud is equal to or more than a predetermined number that can be used to recognize the target object, the 3D object recognition unit 122a performs point cloud recognition processing on a localized speed point cloud thereof. The 3D object recognition unit 122a estimates attribute information regarding the recognized object by the point cloud recognition processing. Hereinafter, the attribute information based on the point cloud is referred to as 3D attribute information. The 3D attribute information can include, for example, information indicating the material of the recognized object.

In a case where the reliability of the estimated 3D attribute information is equal to or more than a certain value, the 3D object recognition unit 122a integrates the 3D region information regarding the localized point cloud and the 3D attribute information, and outputs the integrated 3D region information and 3D attribute information as the 3D recognition information.

The image combining unit 150 acquires the speed point cloud from the photodetection distance measuring unit 12a, and acquires the captured image from the camera 13. The image combining unit 150 generates a distance image on the basis of the point cloud and the captured image. The distance image is an image including information indicating a distance from the measurement point.

The image combining unit 150 combines the distance image and the captured image while matching the coordinates by coordinate system conversion, and generates a combined image by an RGB image. The combined image generated here is an image in which each pixel has color and the distance information. Note that the resolution of the distance image is lower than that of the captured image output from the camera 13. Thus, the image combining unit 150 may match the resolution with the captured image by processing such as upscaling on the distance image.

The image combining unit 150 outputs the generated combined image. Note that the combined image refers to an image in which new information is added to each pixel of the image by combining distance and other information. The combined image includes 2D coordinate information, color information, the distance information, and luminance information for each pixel. The combined image is supplied to the 2D object detection unit 151 and the I/F unit 123a.

The 2D object detection unit 151 extracts a partial image corresponding to the 3D region information from the combined image supplied from the image combining unit 150 on the basis of the 3D region information output from the 3D object detection unit 121a. Furthermore, the 2D object detection unit 151 detects an object from the extracted partial image, and generates region information indicating, for example, a rectangular region having a minimum area including the detected object. The region information based on the captured image is referred to as 2D region information. The 2D region information is represented as a point or a set of pixels in which a value given for each measurement point or pixel by the photodetection distance measuring unit 12a falls within a designated range.

The 2D object detection unit 151 outputs the generated partial image and the 2D region information as 2D detection information.

The 2D object recognition unit 152 acquires a partial image included in the 2D detection information output from the 2D object detection unit 151, performs image recognition processing such as inference processing on the acquired partial image, and estimates attribute information related to the partial image. In this case, for example, when the target is a vehicle, the attribute information is expressed as a unique numerical value indicating that the target belongs to the vehicle assigned to each pixel of the image. Hereinafter, the attribute information based on the partial image (captured image) is referred to as 2D attribute information.

When the reliability of the estimated 2D attribute information is equal to or more than a certain level, that is, when the recognition processing can be executed significantly, the 2D object recognition unit 152 integrates the 2D coordinate information, the attribute information, and the reliability for each pixel and the 2D region information, and outputs the integrated information as 2D recognition information. Note that, in a case where the reliability of the estimated 2D attribute information is less than a certain value, the 2D object recognition unit 152 may integrate and output respective pieces of information excluding the attribute information. Furthermore, the 2D object recognition unit 152 outputs the 2D attribute information and the 2D region information to the 3D object recognition unit 122a and an imaging control unit 171.

The combined point cloud output from the point cloud combining unit 140 and the 3D recognition information output from the 3D object recognition unit 122a are input to the I/F unit 123a. Furthermore, the combined image output from the image combining unit 150 and the 2D recognition information output from the 2D object recognition unit 152 are input to the I/F unit 123a. The I/F unit 123a selects information to be output from the input combined point cloud, the 3D recognition information, the combined image, and the 2D recognition information according to the setting from the outside, for example. For example, the I/F unit 123a outputs the distance information, the 3D recognition information, and the 2D recognition information.

Similarly to the distance measurement control unit 170 in FIG. 10, the distance measurement control unit 170 generates the distance measurement control signal for controlling distance measurement by the photodetection distance measuring unit 12a on the basis of the 3D recognition information and the mode setting information. For example, the distance measurement control signal may include the 3D recognition information and the mode setting information. The distance measurement control unit 170 supplies the generated distance measurement control signal to the photodetection distance measuring unit 12a.

The imaging control unit 171 generates the imaging control signal for controlling the angle of view, exposure, diaphragm, zoom, and the like of the camera 13 on the basis of the 2D recognition information output from the 2D object recognition unit and the mode setting information. For example, in a case where the reliability of the 2D recognition information is low, the imaging control unit 171 may generate the imaging control signal including information for controlling the exposure and the diaphragm.

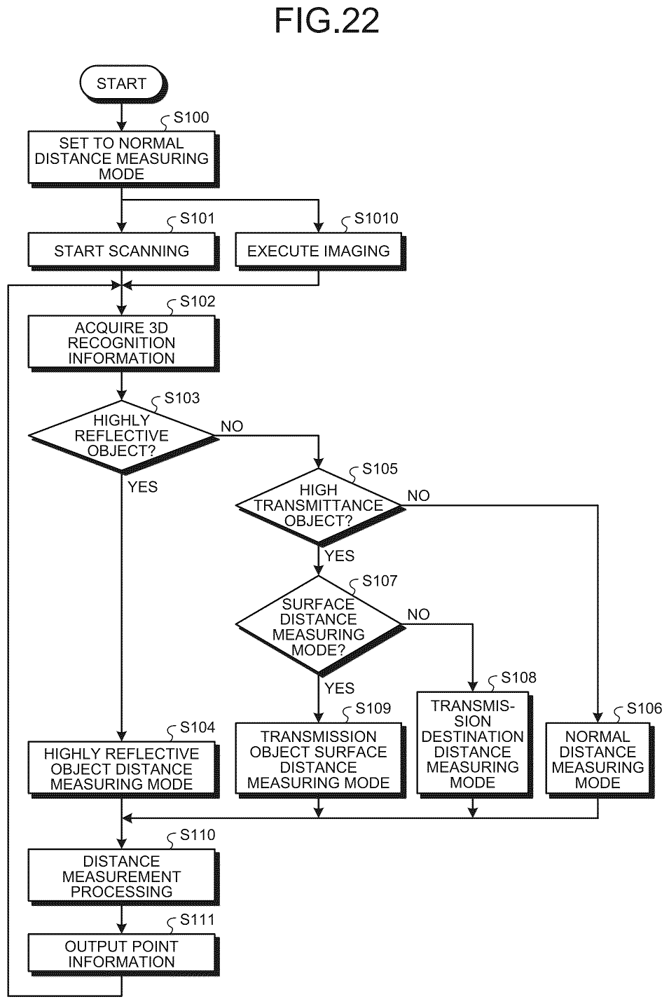

FIG. 22 is a flowchart of an example illustrating processing according to the second embodiment. Note that, in FIG. 22, description of processing common to that in FIG. 17 described above will be omitted as appropriate.

In step S100, in the measurement device 1b, the distance measurement control unit 170 sets the distance measuring mode to the normal distance measuring mode. The distance measurement control unit 170 passes the distance measurement control signal including the mode setting information indicating the distance measuring mode to the photodetection distance measuring unit 12a. In the next step S101, the photodetection distance measuring unit 12a starts scanning with laser light in response to the distance measurement control signal and acquires the point cloud information.

Furthermore, in parallel with the processing of step S101, imaging by the camera 13 is executed in step S1010. The captured image acquired by the camera 13 is supplied to the image combining unit 150 and the point cloud combining unit 140.

In the measurement device 1b, the 3D object detection unit 121a performs object detection on the basis of the combined point cloud output from the point cloud combining unit 140, and acquires the 3D detection information. The 3D object recognition unit 122a performs the object recognition processing on the basis of the 3D detection information acquired by the 3D object detection unit 121a and the 2D attribute information and the 2D region information supplied from the 2D object recognition unit 152, and acquires the 3D recognition information. The 3D recognition information is passed to the I/F unit 123a and the distance measurement control unit 170.

Furthermore, in the measurement device 1b, the 2D object detection unit 151 performs object detection processing on the basis of the combined image supplied from the image combining unit 150 and the 3D region information supplied from the 3D object detection unit 121a, and outputs the 2D detection information. The 2D object recognition unit 152 performs the object recognition processing on the basis of the 2D detection information supplied from the 2D object detection unit 151, and generates 2D recognition information. The 2D object recognition unit 152 passes the 2D recognition information to the I/F unit 123a, and passes the 2D attribute information and the 2D region information included in the 2D recognition information to the 3D object recognition unit 122a.

Since the processing of step S102 and subsequent steps is the same as the processing of step S102 and subsequent steps in FIG. 17 described above, the description thereof will be omitted here.

In the second embodiment, the 3D object recognition unit 122a performs the object recognition processing using 2D attribute information and 2D region information based on a captured image captured by the camera 13 together with the 3D detection information. Thus, the 3D object recognition unit 122a can perform object recognition with higher accuracy. Therefore, the determination processing by the determination unit 1172 can be performed more accurately. In addition, the distance measurement of the surface of the high transmittance object and the transmission destination can be performed with higher accuracy.

### 6. OTHER EMBODIMENTS

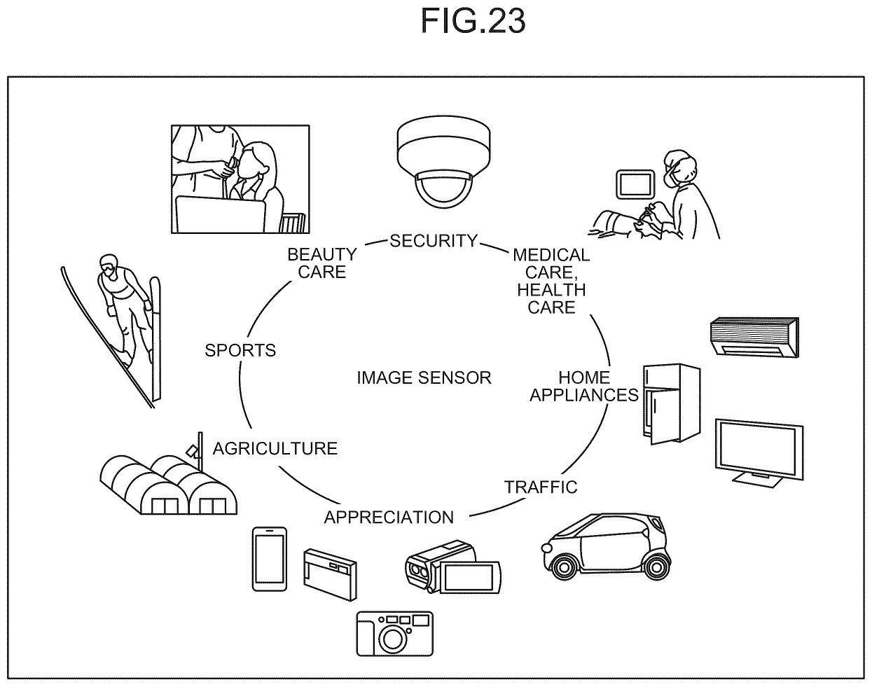

Next, as another embodiment of the present disclosure, the first embodiment and the modification thereof of the present disclosure, and an application example of the second embodiment will be described. FIG. 23 is a diagram illustrating an example of use of the measurement devices 1, 1a, and 1b according to the first embodiment and its modification described above and the second embodiment according to another embodiment of the present disclosure.

The measurement devices 1, 1a, and 1b described above can be used, for example, in various cases of sensing light such as visible light, infrared light, ultraviolet light, and X-rays as described below.
A device that captures an image to be used for appreciation, such as a digital camera or a portable device with a camera function.
A device used for traffic, such as an in-vehicle sensor that captures images of the front, rear, surroundings, and inside of an automobile for safe driving such as automatic stopping, recognition of a driver's condition, and the like, a monitoring camera that monitors traveling vehicles and roads, and a distance measuring sensor that measures a distance between vehicles and the like.
A device used for home appliances such as a TV, a refrigerator, and an air conditioner in order to capture an image of a gesture of a user and operate the device according to the gesture.
A device used for medical care or health care, such as an endoscope or a device that performs angiography by receiving infrared light.
A device used for security, such as a monitoring camera for crime prevention or a camera for person authentication.
A device used for beauty care, such as a skin measuring instrument for capturing an image of skin or a microscope for capturing an image of a scalp.
A device used for sports, such as an action camera or a wearable camera for sports or the like.
A device used for agriculture, such as a camera for monitoring conditions of fields and crops.

Note that the effects described in the present specification are merely examples and are not limited, and other effects may be provided.

Note that the present technology can also have the following configurations.

(1) A measurement device comprising:
a receiving unit that receives reflected light of laser light reflected by a target object and polarization-separates the received reflected light into first polarized light and second polarized light; and
a recognition unit that performs object recognition on the target object on a basis of the first polarized light and the second polarized light.
   (2) The measurement device according to the above (1), further comprising:
a determination unit that determines a reception timing of the reflected light on a basis of the first polarized light and the second polarized light, wherein
the recognition unit
performs the object recognition according to the reception timing determined by the determination unit.
   (3) The measurement device according to the above (2), wherein
the determination unit
performs determination on a basis of a comparison result of intensity of the first polarized light and intensity of the second polarized light.
   (4) The measurement device according to the above (3), wherein
the determination unit
performs identification of whether or not the target object is a highly reflective object on a basis of the comparison result, and performs the determination depending on a result of the identification.
   (5) The measurement device according to the above (3), wherein
the determination unit
performs identification of whether the target object is a highly reflective object or a high transmittance object, or neither the highly reflective object nor the high transmittance object on a basis of the comparison result, and performs the determination depending on a result of the identification.
   (6) The measurement device according to the above (5), wherein
the determination unit
selects, in a case where the target object is identified as the high transmittance object, the reception timing depending on mode setting from a first time of a temporally earliest peak among peaks corresponding to the high transmittance object and a second time of a peak after the first time.
   (7) The measurement device according to the above (5) or (6), wherein
the determination unit
determines, in a case where the target object is identified as neither the highly reflective object nor the high transmittance object, that a reception time of reflected light having a highest signal level out of the reflected light is the reception timing.
   (8) The measurement device according to any one of the above (1) to (7), further comprising:
an image sensor that outputs a captured image on a basis of reception light, wherein
the recognition unit
performs the object recognition on the target object on a basis of the first polarized light, the second polarized light, and the captured image.
   (9) The measurement device according to the above (8), wherein
the recognition unit
performs the object recognition on the target object on a basis of recognition information based on three-dimensional information in which the target object is recognized on a basis of the first polarized light and the second polarized light and recognition information based on two-dimensional information in which the target object is recognized on a basis of the captured image.
   (10) The measurement device according to any one of the above (1) to (9), wherein
one of the first polarized light and the second polarized light is polarized light by a transverse electric (TE) wave, and the other is polarized light by a transverse magnetic (TM) wave.
   (11) The measurement device according to any one of the above (1) to (10), wherein
the receiving unit
receives reflected light of the laser light reflected by the target object, the laser light being modulated by pulse modulation.
   (12) The measurement device according to any one of the above (1) to (10), wherein
the receiving unit
receives reflected light of the laser light reflected by the target object, the laser light being modulated by a frequency continuously-modulated wave.
   (13) A measurement method, comprising:
a reception step of receiving reflected light of laser light reflected by a target object; and
a recognition step of performing object recognition on the target object on a basis of first polarized light and second polarized light obtained by polarization separation of the reflected light received in the reception step.
   (14) An information processing device, comprising:
a recognition unit that receives reflected light of laser light reflected by a target object, and perform object recognition on the target object on a basis of first polarized light and second polarized light obtained by polarization separation of the received reflected light.

### REFERENCE SIGNS LIST

1, 1a, 1b, 510 MEASUREMENT DEVICE
10, 10a, 10b SENSOR UNIT
11, 11a, 11b SIGNAL PROCESSING UNIT
12a, 12b PHOTODETECTION DISTANCE MEASURING UNIT
50r, 50p, 51r, 51p, 52p, 52r, 52te, 52tm, 53p, 53r, 53te, 53tm, 54p, 54r, 54te, 54tm PEAK
100 SCANNING UNIT
101a, 101b OPTICAL TRANSMITTING UNIT
102 PBS
103a, 103c FIRST OPTICAL RECEIVING UNIT
103b, 103d SECOND OPTICAL RECEIVING UNIT
116a, 116b TRANSMISSION LIGHT CONTROL UNIT
117a, 117b RECEPTION SIGNAL PROCESSING UNIT
121, 121a 3D OBJECT DETECTION UNIT
122, 122a 3D OBJECT RECOGNITION UNIT
123, 123a I/F UNIT
130 POINT CLOUD GENERATION UNIT
140 POINT CLOUD COMBINING UNIT
150 IMAGE COMBINING UNIT
151 2D OBJECT DETECTION UNIT
152 2D OBJECT RECOGNITION UNIT
170 DISTANCE MEASUREMENT CONTROL UNIT
171 IMAGING CONTROL UNIT
502, 542, 601 VIRTUAL IMAGE
600 TARGET OBJECT
610 WINDSHIELD
620, 622 REFLECTION
621 DRIVER
1160 TIMING GENERATION UNIT
1170a TE RECEIVING UNIT
1170b TM RECEIVING UNIT
1171a, 1171b TIMING DETECTION UNIT
1172 DETERMINATION UNIT
1173 DISTANCE CALCULATION UNIT
1174 TRANSFER UNIT

1. A measurement device comprising:
a receiving unit that receives reflected light of laser light reflected by a target object and polarization-separates the received reflected light into first polarized light and second polarized light; and
a recognition unit that performs object recognition on the target object on a basis of the first polarized light and the second polarized light.

2. The measurement device according to claim 1, further comprising:
a determination unit that determines a reception timing of the reflected light on a basis of the first polarized light and the second polarized light, wherein
the recognition unit
performs the object recognition according to the reception timing determined by the determination unit.

3. The measurement device according to claim 2, wherein
the determination unit
performs determination on a basis of a comparison result of intensity of the first polarized light and intensity of the second polarized light.

4. The measurement device according to claim 3, wherein
the determination unit
performs identification of whether or not the target object is a highly reflective object on a basis of the comparison result, and performs the determination depending on a result of the identification.

5. The measurement device according to claim 3, wherein
the determination unit
performs identification of whether the target object is a highly reflective object or a high transmittance object, or neither the highly reflective object nor the high transmittance object on a basis of the comparison result, and performs the determination depending on a result of the identification.

6. The measurement device according to claim 5, wherein
the determination unit
selects, in a case where the target object is identified as the high transmittance object, the reception timing depending on mode setting from a first time of a temporally earliest peak among peaks corresponding to the high transmittance object and a second time of a peak after the first time.

7. The measurement device according to claim 5, wherein
the determination unit
determines, in a case where the target object is identified as neither the highly reflective object nor the high transmittance object, that a reception time of reflected light having a highest signal level out of the reflected light is the reception timing.

8. The measurement device according to claim 1, further comprising:
an image sensor that outputs a captured image on a basis of reception light, wherein
the recognition unit
performs the object recognition on the target object on a basis of the first polarized light, the second polarized light, and the captured image.

9. The measurement device according to claim 8, wherein
the recognition unit
performs the object recognition on the target object on a basis of recognition information based on three-dimensional information in which the target object is recognized on a basis of the first polarized light and the second polarized light and recognition information based on two-dimensional information in which the target object is recognized on a basis of the captured image.

10. The measurement device according to claim 1, wherein
one of the first polarized light and the second polarized light is polarized light by a transverse electric (TE) wave, and the other is polarized light by a transverse magnetic (TM) wave.

11. The measurement device according to claim 1, wherein
the receiving unit
receives reflected light of the laser light reflected by the target object, the laser light being modulated by pulse modulation.

12. The measurement device according to claim 1, wherein
the receiving unit
receives reflected light of the laser light reflected by the target object, the laser light being modulated by a frequency continuously-modulated wave.

13. A measurement method, comprising:
a reception step of receiving reflected light of laser light reflected by a target object; and
a recognition step of performing object recognition on the target object on a basis of first polarized light and second polarized light obtained by polarization separation of the reflected light received in the reception step.

14. An information processing device, comprising:
a recognition unit that receives reflected light of laser light reflected by a target object, and perform object recognition on the target object on a basis of first polarized light and second polarized light obtained by polarization separation of the received reflected light.
